(19) United States
(12) Patent Application Publication
(10) Pub. No.: US 2024/0331393 A1
(43) Pub. Date: Oct. 3, 2024

(54) SYSTEMS AND METHODS FOR GENERATING NOTIFICATIONS RELATED TO SUSPICIOUS INDIVIDUALS

(71) Applicant: William Holloway Petrey, JR., Frisco, TX (US)

(72) Inventors: William Holloway Petrey, Jr., Frisco, TX (US); Steven Mason, Las Vegas, NV (US)

(73) Assignee: William Holloway Petrey, JR., Frisco, TX (US)

(21) Appl. No.: 18/741,432

(22) Filed: Jun. 12, 2024

Related U.S. Application Data
(63) Continuation-in-part of application No. 18/518,136, filed on Nov. 22, 2023.
Application No. 18/518,136 is a continuation-in-part of application No. 17/688,340, filed on Mar. 7, 2022, now Pat. No. 11,915,485.
Application No. 17/688,340 is a continuation of application No. 16/910,949, filed on Jun. 24, 2020, now Pat. No. 11,270,129.
(60) Provisional application No. 62/866,278, filed on Jun. 25, 2019.

(51) Int. Cl. G06V 20/54; G06V 20/62; G06V 40/16; G08B 7/06; G08B 25/10

(52) U.S. Cl. CPC G06V 20/54; G06V 20/63; G06V 40/161; G08B 7/06; G06V 20/625; G08B 25/10

(57) ABSTRACT

Methods, systems, and computer-readable media for suspicious individual notification. The method includes capturing a video feed of at least a portion of a real estate property. The method also includes determining, using at least the video feed, identifiers of an individual entering the real estate property. The method further includes detecting, based on the identifiers and by using machine learning models, a match to an entry in a database of suspicious individuals (DSI). The method also includes determining a strength of the match to the entry in the DSI. The method further includes determining that the strength of the match is greater than a probability threshold associated with the entry in the DSI. Responsive to determining that the strength of the match is above the probability threshold, the method also includes transmitting an alert to one or more mobile computing devices associated with one or more designated entities.

### CROSS-REFERENCES TO RELATED APPLICATIONS

This application claims priority to and is a continuation-in-part of U.S. patent application Ser. No. 18/518,136 (Attorney Docket No. 85299-116) filed Nov. 22, 2023, entitled “System and Method for Predicting the Presence of an Entity at Certain Locations,” which is a continuation-in-part of U.S. patent application Ser. No. 17/688,340 (Attorney Docket No. 85299-106) filed Mar. 7, 2022, now U.S. Pat. No. 11,915,485, entitled “System and Method for Correlating Electronic Device Identifiers and Vehicle Information,” which is a continuation of U.S. patent application Ser. No. 16/910,949 (Attorney Docket No. 85299-101) filed Jun. 24, 2020, now U.S. Pat. No. 11,270,129, entitled “System and Method for Correlating Electronic Device Identifiers and Vehicle Information,” which claims priority to and the benefit of U.S. Provisional Application Ser. No. 62/866,278 (Attorney Docket No. 85299-100) filed Jun. 25, 2019, the entire disclosures of which are hereby incorporated by reference.

### TECHNICAL FIELD

This disclosure relates generally to information correlation. More specifically, the present disclosure relates to a system and method for identifying and providing notifications of suspicious individuals entering a real estate property.

### BACKGROUND

Many public and private areas, including airports, business parks, companies, border checkpoints, neighborhoods, etc. employ measures to enhance the safety of the people and property on the area premises. For example, some neighborhoods are gated and visitors to the communities may be forced to check-in with a guard at a security gate prior to being allowed into the neighborhood. Some neighborhoods employ a crime watch group that includes a group of concerned citizens who work together with law enforcement to help keep their neighborhood safe. Such a program may rely on volunteers to patrol the neighborhood to help law enforcement discover and/or thwart suspicious and/or criminal activity. However, these and other conventional measures lack the ability to correlate certain information that provides for enhanced identification, tracking, and notification of and/or to suspicious vehicles/individuals.

Further, people may desire to receive notifications when suspicious individuals enter their real estate property. For example, people may desire to receive a notification when a burglar or other violent criminal enters their real estate property. Video surveillance is often employed to monitor homes and other types of real estate properties. Conventional video surveillance systems, however, do not discriminate between suspicious and non-suspicious individuals. Rather, conventional video surveillance systems generally send notifications for every person the systems detect. There is currently a lack of a mechanism for identifying and providing notifications of suspicious individuals entering a real estate property.

### SUMMARY

In general, the present disclosure provides systems and methods for suspicious person identify and notification.

This disclosure provides a computer-implemented method including capturing, using at least one camera, a video feed of at least a portion of a real estate property. The computer-implemented method also includes determining, using at least the video feed, one or more identifiers of an individual entering the real estate property. The computer-implemented method further includes detecting, based at least on the one or more identifiers and by using one or more machine learning models, a match to an entry in a database of suspicious individuals (DSI). The computer-implemented method also includes determining a strength of the match to the entry in the DSI. The computer-implemented method further includes determining that the strength of the match is greater than a probability threshold associated with the entry in the DSI. Responsive to determining that the strength of the match is above the probability threshold, the computer-implemented method also includes, transmitting an alert to one or more mobile computing devices associated with one or more designated entities.

This disclosure also provides a system including, in one embodiment, one or more memory devices and one or more processing. The one or more memory devices store instructions. The one or more processing devices are communicatively coupled to the one or more memory devices. The one or more processing devices are configured to execute the instructions to capture, using at least one camera, a video feed of at least a portion of a real estate property. The one or more processing devices are also configured to execute the instructions to determine, using at least the video feed, one or more identifiers of an individual entering the real estate property. The one or more processing devices are further configured to execute the instructions to determine, based at least on the one or more identifiers and by using one or more machine learning models, a match to an entry in a database of suspicious individuals (DSI). The one or more processing devices are also configured to execute the instructions to determine a strength of the match to the entry in the DSI. The one or more processing devices are further configured to execute the instructions to compare the strength of the match to a probability threshold associated with the entry in the DSI. When the strength of the match is greater than the probability threshold, the one or more processing devices are also configured to execute the instructions to, transmit an alert to one or more mobile computing devices associated with one or more designated entities.

This disclosure further provides a tangible, non-transitory computer-readable medium storing instructions that, when executed, cause one or more processing devices to capture, using at least one camera, a video feed of at least a portion of a real estate property. The instructions also cause the one or more processing devices to determine, using at least the video feed, one or more identifiers of an individual entering the real estate property. The instructions further cause the one or more processing devices to determine, based at least on the one or more identifiers and by using one or more machine learning models, a match to an entry in a database of suspicious individuals (DSI). The instructions also cause the one or more processing devices to determine a strength of the match to the entry in the DSI. The instructions further cause the one or more processing devices to compare the strength of the match to a probability threshold associated with the entry in the DSI. When the strength of the match is greater than the probability threshold, the instructions also cause the one or more processing devices to transmit an alert to one or more mobile computing devices associated with one or more designated entities.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

It should be noted that the term “cellular media access control (MAC) address” may refer to a MAC, international mobile subscriber identity (IMSI), mobile station international subscriber directory number (MSISDN), enhanced network selection (ENS), or any other form of unique identifying number.

### BRIEF DESCRIPTION OF THE DRAWINGS

For a more complete understanding of this disclosure and its advantages, reference is now made to the following description, taken in conjunction with the accompanying drawings, in which:

FIG. 1A illustrates a high-level component diagram of an example of a system architecture, according to certain embodiments of this disclosure;

FIG. 1B illustrates an example of trilateration using the system architecture of FIG. 1A, according to certain embodiments of this disclosure;

FIG. 2 illustrates details pertaining to various components of the system architecture of FIG. 1A, according to certain embodiments of this disclosure;

FIG. 3 illustrates an example of a method for monitoring vehicle traffic, according to certain embodiments of this disclosure;

FIG. 4 illustrates another example of a method for monitoring vehicle traffic, according to certain embodiments of this disclosure;

FIG. 5 illustrates examples of user interfaces presented on computing devices during monitoring vehicle traffic, according to certain embodiments of this disclosure;

FIG. 6 illustrates an example of an individual entering a real estate property, according to certain embodiments of this disclosure;

FIG. 7 illustrates another example of a high-level component diagram of an example of a system architecture, according to certain embodiments of this disclosure;

FIG. 8 illustrates an example of a method for providing notification of suspicious individuals entering real estate properties, according to certain embodiments of this disclosure;

FIG. 9 illustrates an example of a method for recommending individuals to add to a database of suspicious individuals, according to certain embodiments of this disclosure; and

FIG. 10 illustrated an example of a computer system, according to certain embodiments of this disclosure.

### DETAILED DESCRIPTION

Improvement is desired in the field of public safety for certain areas (e.g., neighborhood, airport, business park, border checkpoint, city, etc.). As discussed above, there are various measures that may be conventionally used, such as gated communities, neighborhood crime watch groups, and so forth. However, the conventional measures lack efficiency and accuracy in identifying suspicious vehicles/individuals and reporting of the suspicious vehicles/individuals, among other things. In some instances, the conventional measures may fail to report the suspicious vehicle/individual, altogether. The causes of the inefficient and/or failed reporting may be at least in part attributable to people (e.g., neighbors in a neighborhood) not having access to verified vehicle and/or personal information of an individual. Further, the conventional measures lack the ability to quickly, accurately, and automatically identify the vehicle as a suspicious vehicle, correlate vehicle information (e.g., license plate identifier (ID)), electronic device information (e.g., electronic device identifier (ID)), face information, etc., and/or perform a preventative action based on the identification.

Take the following example for illustrative purposes. A neighbor may witness an unknown vehicle drive through the neighborhood several times within a given time period during a day. The neighbor may not recognize the license plate ID or driver and may think about reporting the unknown vehicle to law enforcement. Instead, the neighbor may decide to proceed to do another activity. Subsequently, the person may burglarize a house in the neighborhood. Even if the neighbor attempted to lookup the license plate ID, and was able to find out information about an owner of the vehicle, the neighbor may not be able to determine whether the driver of the vehicle is the actual owner, the neighbor may not be able to determine whether the owner or driver is on a crime watch list, and so forth. Further, the neighbor may not be privy to the electronic device identifier of the electronic device the suspicious individual is carrying or that is installed in the vehicle, which may be used to track the whereabouts of the individual/vehicle in a monitored area. Even if a neighbor obtains an electronic device identifier, there currently is no technique for determining personal information associated with the electronic device identifier. To reiterate, conventional techniques for public safety lack the ability to identify a suspicious vehicle/individual and/or to correlate vehicle information, facial information, and/or electronic device identifiers of electronic devices of the driver to make an informed decision quickly, accurately, and automatically.

Aspects of the present disclosure relate to embodiments that overcome the shortcomings described above. The present disclosure relates to a system and method for correlating electronic device identifiers with vehicle information. The system may include one or more license plate detection zones, one or more electronic device detection zones, and/or one or more facial detection zones. The zones may be partially or wholly overlapping and there may be multiple zones established that span a desired area (e.g., a neighborhood, a city block, a public/private parking lot, any street, etc.). The license plate detection zones, the electronic device detection zones, and/or the facial detection zones may include devices that are communicatively coupled to one or more computing systems via a network. The license plate detection zones may include one or more cameras configured to capture images of at least license plates on vehicles that enter the license plate detection zone. The electronic device detection zone may include one or more electronic device identification sensors, such as a Wi-Fi signal detection device or a Bluetooth® signal detection device. The electronic device identification sensors may be configured to detect and store Wi-Fi Machine Access Control (MAC) addresses, Bluetooth MAC addresses, and/or cellular MAC addresses (e.g., International Mobile Subscriber Identity (IMSI), Mobile Station International Subscriber Directory Number (MSISDN), and Electronic Serial Numbers (ESN)) of electronic devices that enter the electronic device detection zone based on the signals emitted by the electronic devices. The facial detection zones may include one or more cameras configured to capture images or digital frames that are used to recognize a face. Any suitable MAC address may be detected, and to that end, a MAC address may be any combination of the IDs described herein (e.g., MAC, MSISIDN, IMSI, ESN, etc.).

The computing system may analyze the images captured by the cameras and detect a license plate identifier (ID) of a vehicle. The license plate ID may be compared with trusted license plate IDs that are stored in a database. When there is not a trusted license plate ID that matches the license plate ID, the computing system may identify the vehicle as a suspicious vehicle. Then, the computing system may correlate the license plate ID of the vehicle with at least one of the stored electronic device identifiers. In some embodiments, the license plate ID and the at least one of the stored electronic device identifiers may be correlated with a face of the individual. In some embodiments, personal information, such as name, address, Bluetooth MAC address, Wi-Fi MAC address, criminal record, whether the suspicious individual is on a crime watch list, etc. may be retrieved using the license plate ID or the at least one of the stored electronic device identifiers that is correlated with the license plate ID of the suspicious vehicle.

The system may include several computer applications that may be accessed by registered users of the system. For example, a client application may be accessed by a computing device of a user, such as a neighbor in a neighborhood implementing the system. The client application may present a user interface including an alert when a suspicious vehicle and/or individual is detected. The user interface may present several preventative actions for the user. For example, the user may contact the suspicious individual using the personal information (e.g., send a threatening text message), notify law enforcement, and so forth. Accordingly, a client application may be accessed by a computing device of a law enforcer. The client application may present a user interface including the notification that a suspicious vehicle and/or individual is detected in the particular zones.

Take the following example of a setup of the system for illustration purposes. In a neighborhood, that may only be accessed by two entrances, license plate detection zones and electronic device detection zones may be placed to cover both lanes at both entrances. In some instances, a facial detection zone may be placed at the entrances with the other zones. Each vehicle may be correlated with each electronic device that enters the neighborhood. Further, the recognized face may be correlated with the electronic device and the vehicle information. The houses inside the neighborhood may setup electronic device detection zones and/or a facial detection zone inside their property to detect electronic device IDs and/or faces and compare them with electronic device IDs and/or faces in a database that stores every correlation that has been made by the system to date (including the most recent correlations of electronic device IDs, faces, and/or vehicles entering the neighborhood). The home owner may be notified via the client application on their computing device if an electronic device and/or face is detected on their property. Further, in some embodiments, the individual associated with the electronic device and/or face may be notified on the electronic device that the homeowner is aware of their presence. If a known criminal with a warrant is detected at either the zones at the entrance or at the zones at the homeowner's property, the appropriate law enforcement agency may be notified of their whereabouts.

The disclosed techniques provide numerous benefits over conventional systems. For example, the system provides efficient, accurate, and automatic identification of suspicious vehicles and/or individuals. Further, the system enables correlating vehicle license plate IDs with electronic device identifiers to enable enhanced detection and/or preventative actions, such as directly communicating with the electronic device of the suspicious individual and/or notifying law enforcement using the client application in real-time or near real-time when the suspicious vehicle enters one or more zones. For example, once the electronic device identifier is detected, a correlation may be obtained with a license plate ID to obtain personal information about the owner that enables contacting the owner directly and/or determining whether the owner is a criminal. The client application provides pertinent information pertaining to both the suspicious vehicle and/or individual in a single user interface without the user having to perform any searches of the license plate ID or electronic device identifier. As such, in some embodiments, the disclosed techniques reduce processing, memory, and/or network resources by reducing searches that the user may perform to find the information. Also, the disclosed techniques provide an enhanced user interface that presents the suspicious vehicle and/or individual information in single location, which may improve a user's experience using the computing device.

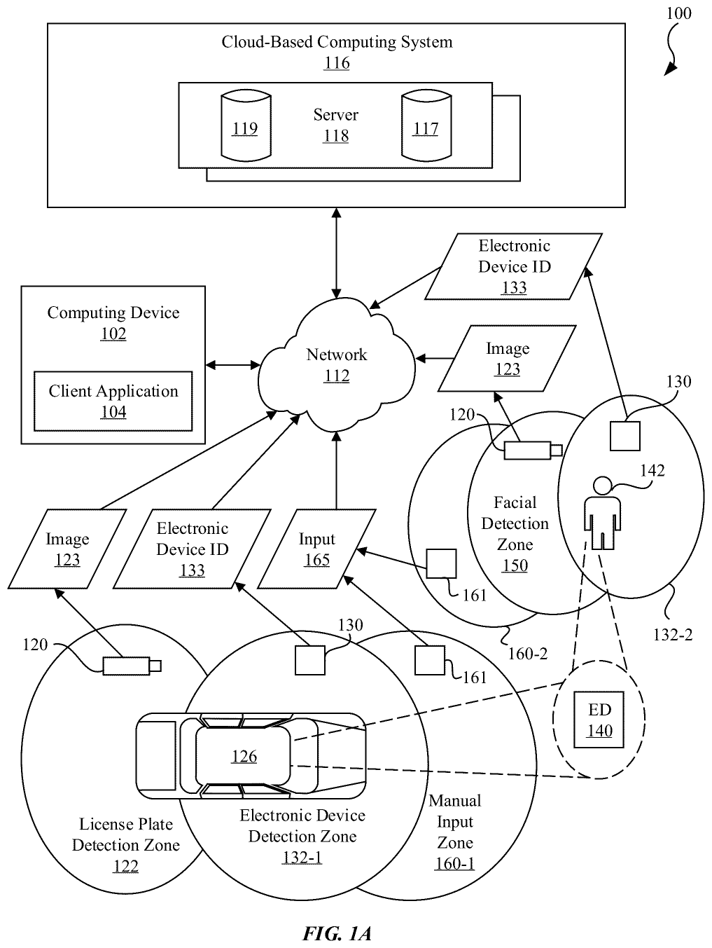

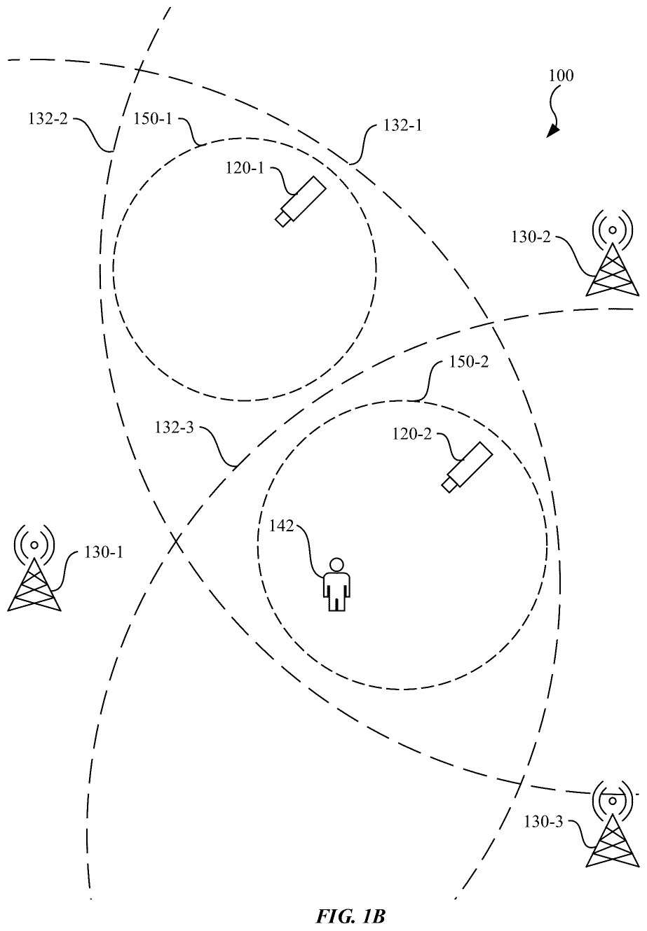

FIG. 1A illustrates a high-level component diagram of a system architecture 100 according to certain embodiments of the present disclosure. In some embodiments, the system architecture 100 may include a computing device 102 communicatively coupled to a cloud-based computing system 116, one or more cameras 120, one or more electronic device identification sensors 130, and/or one or more electronic devices 140 of a suspicious individual. The cloud-based computing system 116 may include one or more servers 118. Each of the computing device 102, the servers 118, the cameras 120, the electronic device identification sensors 130, and the electronic device 140 may include one or more processing devices, memory devices, and network interface devices.

The network interface devices may enable communication via a wireless protocol for transmitting data over short distances, such as Bluetooth, ZigBee, etc. Additionally, the network interface devices may enable communicating data over long distances, and in one example, the computing device 102 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof.

The computing device 102 may be any suitable computing device, such as a laptop, tablet, smartphone, or computer. The computing device may be configured to execute a client application 104 that presents a user interface. The client application 104 may be implemented in computer instructions stored on one or more memory devices and executed by one or more processing devices of the computing device 102. The client application 104 may be a standalone application installed on the computing device 102 or may be an application that is executed by another application (e.g., a website in a web browser).

The computing device 102 may include a display that is capable of presenting the user interface of the client application 104. The user interface may present various screens to a user depending on what type of user is logged into the client application 104. For example, a user, such as a neighbor or person interested in one of the license plate detection zones 122 and/or electronic device detection zone 132, may be presented with a user interface for logging into the system where the user enters credentials (username and password), a user interface that displays alerts of suspicious vehicles and/or individuals in the zones 122 and/or 132 where the user interface includes options for preventative actions, a user interface that presents logged events over time, and so forth. For example, the client application 104 may enable the user to directly contact (e.g., send text message, send email, call) the electronic device 140 of a suspicious individual 142 using personal information obtained about the individual 142. Another user, such as a law enforcer, may be presented with a user interface for logging into the system where the user enters credentials (username and password), a user interface that displays notifications when the user selects to notify law enforcement where the notifications may include information related to the suspicious vehicle and/or individual 142.

In some embodiments, the cameras 120 may be located in the license plate detection zones 122. Although just one camera 120 and one license plate detection zone 122 are depicted, it should be noted that any suitable number of cameras 120 may be located in any suitable number of license plate detection zones 122. For example, multiple license plate detection zones 122 may be used to cover a desired area. A license plate detection zone 122 may refer to an area of coverage that is within the cameras' 120 field of view. The cameras 120 may be any suitable camera and/or video camera capable of capturing a set of images 123 that at least represent license plates of a vehicle 126 that enters the license plate detection zone 122. The set of images 123 may be transmitted by the camera 120 to the cloud-based computing system 116 and/or the computing device 102 via the network 112.

In some embodiments, the electronic device identification sensors 130 may be located in the electronic device detection zones 132. In some embodiments, the license plate detection zone 122 and the electronic device detection zone 132-1 may partially or wholly overlap. The combination of license plate detection zones 122 and the electronic device detection zones 132 may be setup at entrances/exits to certain areas, and/or any other suitable area in a monitored area, to correlate each vehicle information with respective electronic device identifiers 133 of electronic devices 140 being carried in respective vehicles 126. Each of the license plate detection zones 122 and electronic device detection zones 132 may have unique geographic identifiers so the data can be tracked by location. It should be noted that any suitable number of electronic device identification sensors 130 may be located in any suitable number of electronic device detection zones 132. For example, multiple electronic device detection zones 132 may be used to cover a desired area. An electronic device detection zone 132 may refer to an area of coverage that is within the electronic device identification sensor 130 detection area.

In one example, an electronic device detection zone 132-2 and/or a facial detection zone 150 may be setup at a home of a homeowner, such that an electronic device 140 and/or a face of a suspicious individual 142 may be detected and stored when the suspicious individual 142 enters the zone 132-2. The electronic device ID 133 and/or an image of the face may be transmitted to the cloud-based computing system 116 or the computing device 102 via the network 112. In some instances, the suspicious individual 142 may be contacted on their electronic device 140 with a message indicating the homeowner is aware of their presence and to leave the premises. In some instances, if a known criminal individual 142 with a warrant is detected at the combination of zones 122 and 132-1 at an entrance or at the zone 132-2 and 150 at the home, then the proper law enforcement agency may be contacted with the whereabouts of the individual 142.

In some embodiments, the cameras 120 may be located in the facial detection zones 150. Although just one camera 120 and one facial detection zone 150 are depicted, it should be noted that any suitable number of cameras 120 may be located in any suitable number of facial detection zones 150. For example, multiple facial detection zones 150 may be used to cover a desired area. A facial detection zone 150 may refer to an area of coverage that is within the cameras' 120 field of view. The cameras 120 may be any suitable camera and/or video camera capable of capturing a set of images 123 that at least represent faces of an individual 142 that enters the facial detection zone 150. The set of images 123 may be transmitted by the camera 120 to the cloud-based computing system 116 and/or the computing device 102 via the network 112. In some embodiments, the cloud-based computing system 116 and/or the computing device 102 may perform facial recognition by comparing a face detected in the image to a database of faces to find a match and/or perform biometric artificial intelligence that may uniquely identify an individual 142 by analyzing patterns based on the individual's facial textures and shape.

The electronic device identification sensors 130 may be configured to detect a set of electronic device IDs 133 (e.g., Wi-Fi MAC addresses, Bluetooth MAC addresses, and/or cellular MAC addresses) of electronic device 140 within the electronic device detection zone 132. As depicted, the electronic device 140 of a suspicious individual is within the vehicle 126 passing through the electronic device detection zone 132. That is, the electronic device identification sensors 130 may be any suitable Wi-Fi signal detection device capable of detecting Wi-Fi MAC addresses and/or Bluetooth signal detection device capable of detecting Bluetooth MAC addresses of electronic devices 140 that enter the electronic device detection zone 132. The set of images 123 may be transmitted by the camera 120 to the cloud-based computing system 116 and/or the computing device 102 via the network 112. The electronic device identification sensor 130 may store the set of electronic device IDs 133 locally in a memory. The electronic device identification sensor 130 may also transmit the set of electronic device IDs 133 to the cloud-based computing system 116 and/or the computing device 102 via the network 112 for storage.

As noted above, the cloud-based computing system 116 may include the one or more servers 118 that form a distributed computing architecture. Each of the servers 118 may be any suitable computing system and may include one or more processing devices, memory devices, data storage, and/or network interface devices. The servers 118 may be in communication with one another via any suitable communication protocol. The servers 118 may each include the database 117 of trusted vehicle license plate IDs, the personal identification database 119, or both. In some implementations, the database 117 of trusted vehicle license plate IDs and the personal identification database 119 may be stored on the computing device 102.

The database 117 of trusted vehicle license plate IDs may be populated by a processing device adding license plate IDs of vehicles that commonly enter the license plate detection zone 122. In some implementations, the database 117 of trusted vehicle license plate IDs may be populated at least in part by manual entry of license plate IDs associated with vehicles trusted to be within the license plate detection zone 122. For example, the license plate IDs may be added at a manual input zone 160-1 using a computing device 161. These license plate IDs may be associated with vehicles owned by neighbors in a neighborhood, or family members of the neighbors, friends of the neighbors, visitors of the neighbors, contractors hired by the neighbors, any suitable person that is trusted, etc.

The personal identification database 119 may be populated by a processing device adding personal identification information associated with electronic device IDs 133 of electronic devices carried by people that commonly enter the electronic device detection zone 132 (e.g., a list of trusted electronic device IDs). In some implementations, the personal identification database 119 may be populated at least in part by manual entry of personal identification information associated with electronic device IDs 133 associated with electronic devices 140 trusted to be within the electronic device detection zone 132 (e.g., a list of trusted electronic device IDs). For example, the personal identification information associated with electronic device IDs 133 may be added at the manual input zone 160-1 using the computing device 161. These electronic device IDs 133 may be associated with electronic devices 140 owned by neighbors in a neighborhood, or family members of the neighbors, friends of the neighbors, visitors of the neighbors, contractors hired by the neighbors, etc. Further, in some implementations, the personal identification database 119 may be populated by entering a list of known suspect individuals from the police department, people entering or exiting border checkpoints, etc.

The personal identification information for untrusted electronic device IDs may also be entered into the personal identification database 119. The personal identification database 119 may also be populated by a processing device adding personal identification information associated with electronic device IDs 133 of electronic devices carried by people that commonly enter the facial detection zone 132 (e.g., face images of trusted individuals). The face images 123 may be manually entered at manual input zone 160-2 using the computing device 161. The personal identification information may include names, addresses, faces, email addresses, phone numbers, electronic device identifiers associated with electronic devices owned by the people (e.g., Bluetooth MAC addresses, Wi-Fi MAC addresses), correlated license plate IDs with the electronic device identifiers, etc. The correlations between the license plate IDs, the electronic device identifiers, and/or the faces may be performed by a processing device using the data obtained from the cameras 120 and the electronic device identification sensors 130. Some of this information may be obtained from public sources, phone books, the Internet, and/or companies that distribute electronic devices. In some implementations, the personal identification information added to the personal identification database 119 may be associated with people selected based on their residing in or near a certain radius of a geographic region where the zones 122 and/or 132 are set up, based on whether they are on a crime watch list, or the like.

In some implementations, the system 100 uses overlapping detection zones of multiple electronic device identification sensors to narrow the location area of an individual. For example, in FIG. 1B, the three detection zones 132-1, 132-2, and 132-3 of the three electronic device identification sensors 130-1, 130-2, and 130-3 partially overlap with each other. Further, the individual 142 in FIG. 1B is positioned within the overlapping portions of the three detection zones 132-1, 132-2, and 132-3. Thus, when all three electronic device identification sensors 130-1, 130-2, and 130-3 detect an electronic device carried by the individual 142, the system 100 may determine that the individual 142 is located within the overlapping portions of the three detection zones 132-1, 132-2, and 132-3.

In some implementations, the system 100 may further narrow the location area of the individual 142 using trilateration (or multilateration). Each of the three electronic device identification sensors 130-1, 130-2, and 130-3 may determine, based on the signal strength of the electronic device carried by the individual 142, the distance to the individual 142. For example, electronic device identification sensor 130-2 may determine that the electronic device carried by the individual 142 is close to electronic device identification sensor 130-2 when the signal strength is strong or determine that the electronic device is far from electronic device identification sensor 130-2 when the signal strength is weak. Alternatively, or in addition, each of the three electronic device identification sensors 130-1, 130-2, and 130-3 may determine the distance to the individual 142 by measuring the time delay that a signal takes to return to the electronic device identification sensors 130-1, 130-2, and 130-3 from the electronic device carried by the individual 142. For example, electronic device identification sensor 130-3 may determine that the electronic device carried by the individual 142 is close to electronic device identification sensor 130-3 when the time delay is short or determine that the electronic device is far from electronic device identification sensor 130-3 when the time delay is long. “Short” and “long,” as used in the foregoing may refer to any amount of time delay without restriction, so long that the constraint, in any given instance, is that a long time delay be for a greater period of time than a short time delay. The system 100 may, based on the locations of each of the three electronic device identification sensors 130-1, 130-2, and 130-3 and the distances from the electronic device to each of the three electronic device identification sensors 130-1, 130-2, and 130-3, determine the coordinates of the electronic device. For example, the system 100 may determine the coordinates of the electronic device using the follow equations:

$$x = \frac{( {r}_{1}^{2} - {r}_{2}^{2} - {x}_{1}^{2} + {x}_{2}^{2} - {y}_{1}^{2} + {y}_{2}^{2} ) ( 2 {y}_{3} - 2 {y}_{3} ) - ( {r}_{2}^{2} - {r}_{3}^{2} - {x}_{2}^{2} + {x}_{3}^{2} - {y}_{2}^{2} + {y}_{3}^{2} ) ( 2 {y}_{2} - 2 {y}_{1} )}{( 2 {y}_{3} - 2 {y}_{3} ) ( 2 {x}_{2} - 2 {x}_{1} ) - ( 2 {y}_{2} - 2 {y}_{1} ) ( 2 {x}_{3} - 2 {x}_{2} )}$$

$$y = \frac{( {r}_{1}^{2} - {r}_{2}^{2} - {x}_{1}^{2} + {x}_{2}^{2} - {y}_{1}^{2} + {y}_{2}^{2} ) ( 2 {x}_{3} - 2 {x}_{2} ) - ( 2 {x}_{2} - 2 {x}_{1} ) ( {r}_{2}^{2} - {r}_{3}^{2} - {x}_{2}^{2} + {x}_{3}^{2} - {y}_{2}^{2} + {y}_{3}^{2} )}{( 2 {y}_{2} - 2 {y}_{1} ) ( 2 {x}_{3} - 2 {x}_{2} ) - ( 2 {x}_{2} - 2 {x}_{1} ) ( 2 {y}_{3} - 2 {y}_{3} )}$$

wherein:
x, y=coordinates of the electronic device carried by the individual 142;
x₁, y₁=coordinates of electronic device identification sensor 130-1;
r₁=distance between electronic device identification sensor 130-1 and the electronic device;
x₂, y₂=coordinates of electronic device identification sensor 130-2;
r₂=distance between electronic device identification sensor 130-2 and the electronic device;
x₃, y₃=coordinates of electronic device identification sensor 130-3; and
r₃=distance between electronic device identification sensor 130-3 and the electronic device.

Alternatively, or in addition, the system 100 may further narrow the location area of the individual 142 by selecting a different type of detection device located within the overlapping portions of the three detection zones 132-1, 132-2, and 132-3. For example, there are two cameras 120-1 and 120-2 in FIG. 1B with different facial detection zones 150-1 and 150-2. When all three electronic device identification sensors 130-1, 130-2, and 130-3 detect an electronic device carried by the individual 142, the system 100 may select camera 120-2 with facial detection zone 150-2 that is located within the overlapping portions of the three detection zones 132-1, 132-2, and 132-3. The selected camera 120-2 may then detect the location of the individual 142 within facial detection zone 150-2.

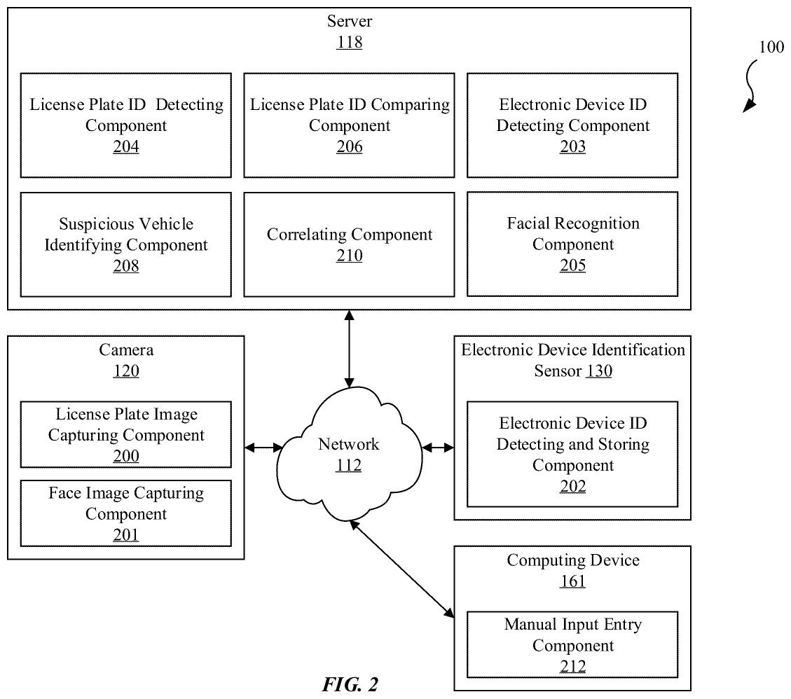

FIG. 2 illustrates details pertaining to various components of the system architecture 100 of FIG. 1A, according to certain implementations of the present disclosure. For example, the camera 120 includes an image capturing component 200 and a face image capturing component 201; the electronic device identification sensor 130 includes an electronic device ID detecting and storing component 202; the server 118 includes an electronic device ID detecting component 203, a license plate ID detecting component 204, a facial recognition component 205, a license plate ID comparing component 206, a suspicious vehicle identifying component 208, and a correlating component 210. In some implementations, the computing device 161 includes a manual input entry component 212. In some implementations, the components 203, 204, 205, 206, 208, and 210 may be included in the computing device 102 executing the client application 104. Each of the components 200, 201, 202, 203, 204, 205, 206, 208, 210, and 212 may be implemented in computer instructions stored on one or more memory devices of their respective device and executed by one or more processors of their respective device.

With regards to the image capturing component 200, the component 200 may be configured to capture a set of images 123 within a license plate detection zone 122. At least some of the captured images 123 may represent license plates of a set of vehicles 126 appearing within the field of view of the cameras 120. The image capturing component 200 may configure one or more camera properties (e.g., zoom, focus, etc.) to obtain a clear image of the license plates. The image capturing component 200 may implement various techniques to extract the license plate ID from the images 123, or the image capturing component 200 may transmit the set of images 123, without analyzing the images 123, to the server 118 via the network 112.

With regards to the electronic device ID detecting and storing component 202, the component 202 may be configured to detect and store a set of electronic device IDs 133 of electronic devices located within one or more electronic device detection zones 132. The electronic device ID detecting and storing component 202 may detect a Wi-Fi signal, cellular signal, and/or a Bluetooth signal from the electronic device and be capable of obtaining the Wi-Fi MAC address, cellular MAC address, and/or Bluetooth MAC address of the electronic device from the signal. The electronic device IDs 133 may be stored locally in memory on the electronic device identification sensor 130, and/or transmitted to the server 118 and/or the computing device 102 via the network 112.

With regards to the license plate ID detecting component 204, the component 204 may be configured to detect, using the set of images 123, a license plate ID of a vehicle 126. The license plate ID detecting component 204 may perform optical character recognition (OCR), or any suitable identifier/text extraction technique, on the set of images 123 to detect the license plate IDs.

With regards to the license plate ID comparing component 206, the component 206 may be configured to compare the license plate ID of the vehicle to a database 117 of trusted vehicle license plate IDs. The license plate ID comparing component 206 may compare the license plate ID with each trusted license plate ID in the database 117 of trusted vehicle license plate IDs.

With regards to the suspicious vehicle identifying component 208, the component 208 may identify the vehicle 126 as a suspicious vehicle 126, the identification based at least in part on the comparison of the license plate ID of the vehicle 126 to the database 117 of trusted vehicle license plate IDs. If there is not a trusted license plate ID that matches the license plate ID of the vehicle 126, then the suspicious vehicle identifying component 208 may identify the vehicle as a suspicious vehicle.

With regards to the correlating component 210, the component 210 may be configured to correlate the license plate ID of the vehicle 126 with at least one of the set of stored electronic device IDs 133. Correlating the license plate ID of the vehicle 126 with at least one of the set of stored electronic device IDs 133 may include comparing one or more time stamps of the set of captured images 123 with one or more time stamps of the set of stored electronic device IDs 133. Also, correlating the license plate ID of the vehicle 126 with at least one of the set of stored electronic device IDs 133 may include analyzing at least one of: (i) at least one strength of signal associated with at least one of the set of stored electronic device IDs 133, and (ii) at least one visually estimated distance of at least one vehicle 126 associated with at least one of the set of stored images 123.

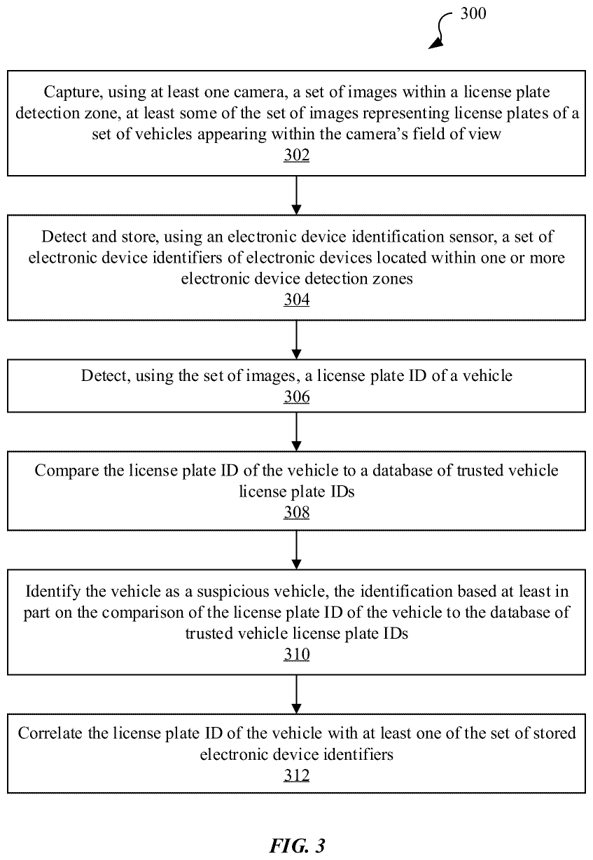

FIG. 3 illustrates an example of a method 300 for monitoring vehicle traffic, according to certain implementations of the present disclosure. The method 300 may be performed by processing logic that may include hardware (circuitry, dedicated logic, etc.), firmware, software, or a combination of both. The method 300 and/or each of their individual functions, subroutines, or operations may be performed by one or more processors of one or more of the devices in FIG. 1A (e.g., computing device 102, cloud-based computing system 116 including servers 118, cameras 120, electronic device identification sensors 130) implementing the method 300. For example, a computing system may refer to the computing device 102 or the cloud-based computing system 116. The method 300 may be implemented as computer instructions that, when executed by a processing device, execute the operations. In certain implementations, the method 300 may be performed by a single processing thread. Alternatively, the method 300 may be performed by two or more processing threads, each thread implementing one or more individual functions, routines, subroutines, or operations of the method 300.

At block 302, a set of images 123 may be captured, using at least one camera 120, within a license plate detection zone 122. At least some of the set of images 123 may represent license plates of a set of vehicles 126 appearing within the camera's field of view. One or more camera properties (e.g., zoomed in, focused, etc.) may be configured to enable the at least one instance of the camera 120 to obtain clear images 123 of the license plates.

At block 304, a set of electronic device identifiers 133 of electronic devices 140 located within one or more electronic device detection zones 132 may be detected and stored using an electronic device identification sensor 130. In some implementations, the electronic device identification sensor 130 may include at least one of a Wi-Fi signal detection device, cellular signal detection device, or a Bluetooth signal detection device. In some implementations, the set of electronic device identifiers 133 may include at least one of a Bluetooth MAC address, cellular MAC address, or a Wi-Fi MAC address. In some implementations, at least one of the set of stored electronic device identifiers 133 may be compared with a list of trusted device identifiers.

At block 306, a license plate ID of a vehicle 126 may be detected using the set of images 123. The images 123 may be filtered, rendered, and/or processed in any suitable manner such that the license plate IDs may be clearly detected using the set of images 123. In some implementations, object character recognition (OCR) may be used to detect the license plate IDs in the set of images 123. The OCR may electronically convert each image in the set of images 123 of the license plate IDs into computer-encoded license plate IDs that may be stored and/or used for comparison.

In some implementations, a face of the individual 142 may be detected by a camera 120 in the facial detection zone 150. An image 123 may be captured by the camera 120 and facial recognition may be performed on the image to detect the face of the individual. The detected face and/or the image 123 may be transmitted to the cloud-based computing system 116 and/or the computing device 102.

At block 308, the license plate ID of the vehicle 126 may be compared to a database of trusted vehicle license plate IDs. In some implementations, the database 117 of trusted vehicle license plate IDs may be populated at least in part by adding license plate IDs of vehicles 126 that commonly enter the license plate detection zone 122 to the database 117 of trusted vehicle license plate IDs. In some implementations, the database 117 of trusted vehicle license plate IDs may be populated at least in part by manual entry of license plate IDs associated with vehicles 126 trusted to be within the license plate detection zone 122. For example, the trusted vehicles may belong to the neighbors, family members of the neighbors, friends of the neighbors, law enforcement, and so forth.

At block 310, the vehicle may be identified as a suspicious vehicle 126. The identification may be based at least in part on the comparison of the license plate ID of the vehicle to the database 117 of trusted vehicle license plate IDs. For example, if the license plate ID is not matched with a trusted license plate ID stored in the database 117 of trusted vehicle license plate IDs, then the vehicle associated with the license plate ID may be identified as a suspicious vehicle 126.

At block 312, the license plate ID of the vehicle 126 may be correlated with at least one of the set of stored electronic device identifiers 133. In some implementations, the face of the individual 142 may also be correlated with the license plate ID and the at least one of the set of stored electronic device identifiers 133. In some implementations, the personal identification database 119 may be accessed. In some implementations, correlating the license plate ID of the vehicle 126 with at least one of the set of stored electronic device identifiers 133 may include comparing one or more time stamps of the set of captured images 123 with one or more time stamps of the set of stored electronic device identifiers 133. In some implementations, correlating the license plate ID of the vehicle 126 with the at least one of the set of stored electronic device identifiers 133 may include analyzing at least one of (i) at least one strength of signal associated with at least one of the set of stored electronic device identifiers 133, and (ii) at least one visually estimated distance of at least one vehicle associated with at least one of the set of stored images 123.

Personal identification information of at least one suspicious individual may be retrieved from the personal identification database 119 by correlating information of the personal identification database 119 with the license plate ID of the vehicle 126 or at least one of the set of electronic device identifiers 133 correlated with the license plate ID of the vehicle 126. The personal identification information may also be obtained using a face detected by the camera 120 to obtain the electronic device ID 133 and/or the license plate ID correlated with the face. The personal identification information may include one or more of a name, a phone number, an email address, a residential address, a Bluetooth MAC address, a cellular MAC address, a Wi-Fi MAC address, whether the suspicious individual is on a crime watch list, a criminal record of the suspicious individual, and so forth.

In some implementations, a user interface may be displayed on one or more computing devices 102 of one or more neighbors when the one or more computing devices are executing the client application 104, and the user interface may present a notification or alert. In some implementations, the computing device 102 may present a push notification on the display screen and the user may provide user input (e.g., swipe the push notification) to expand the notification on the user interface to a larger portion of the display screen. The alert or notification may indicate that there is a suspicious vehicle 126 identified within the license plate detection zone 122 and/or the electronic device detection zone 132-1 and may provide information pertaining to the vehicle 126 (e.g., make, model, color, license plate ID, etc.) and personal identification information of the suspicious individual (e.g., name, phone number, email address, Bluetooth MAC address, cellular MAC address, Wi-Fi MAC address, whether the individual is on a crime watch list, whether the individual has a criminal record, etc.).

Further, the user interface may present one or more options to perform preventative actions. The preventative actions may include contacting an electronic device 140 of the suspicious individual using the personal identification information. For example, a user may use a computing device 102 to transmit a communication (e.g., at least one text message, phone call, email, or some combination thereof) to the suspicious individual using the retried personal information.

In addition, the preventative actions may also include notifying law enforcement of the suspicious vehicle and/or individual. This preventative action may be available if it is determined that the suspicious individual is on a crime watch list. A suspicious vehicle profile may be created. The suspicious vehicle profile may include the license plate ID of the suspicious vehicle and/or the at least one correlated electronic device identifiers (e.g., Bluetooth MAC address, Wi-Fi MAC address). The user may select the notify law enforcement option on the user interface and the computing device 102 of the user may transmit the suspicious vehicle profile to another computing device 102 of a law enforcement entity that may be logged into the client application 104 using a law enforcement account.

In some implementations, the preventative action may include activating an alarm upon detection of the suspicious vehicle 126. The alarm may be located in the neighborhood, for example, on a light pole, a tree, a pole, a sign, a mailbox, a fence, or the like. The alarm may be included in the computing device 102 of a user (e.g., a neighbor) using the client application. The alarm may include auditory (e.g., a message about the suspect, a sound, etc.), visual (e.g., flash certain colors of lights), and/or haptic (e.g., vibrations) elements. In some implementations, the severity of the alarm may change the pattern of auditory, visual, and/or haptic elements based on what kind of crimes the suspicious individual has committed, whether the suspicious vehicle 126 is stolen, whether the suspicious vehicle 126 matches a description of a vehicle involved in an Amber alert, and so forth.

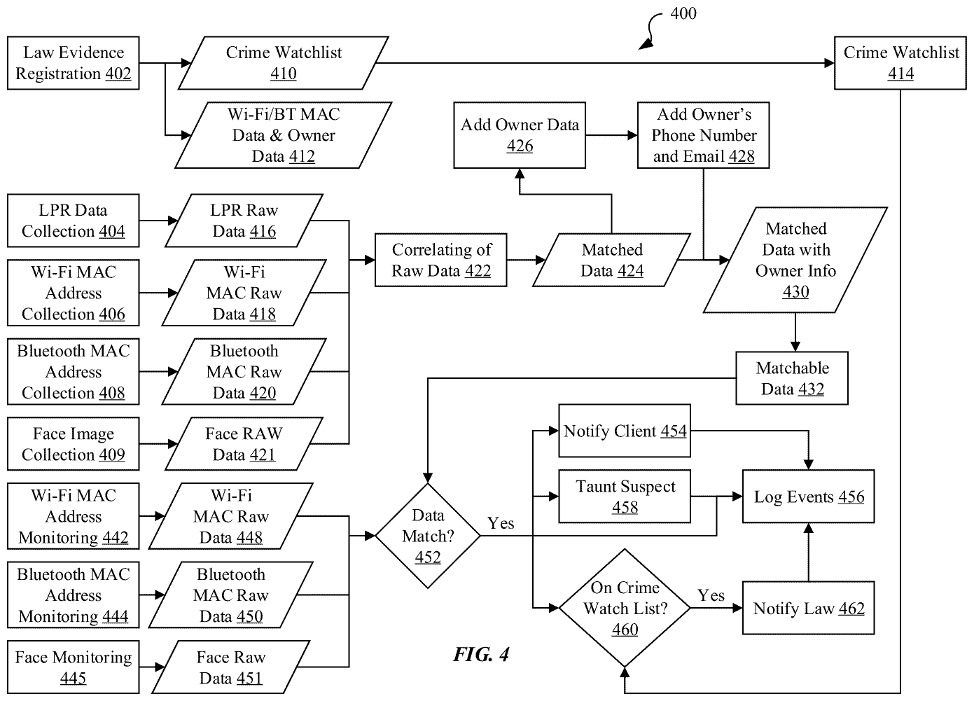

FIG. 4 illustrates another example of a method 400 for monitoring vehicle traffic, according to certain implementations of the present disclosure. Method 400 includes operations performed by one or more processing devices of one or more devices in FIG. 1A (e.g., computing device 102, cloud-based computing system 116 including servers 118, cameras 120, electronic device identification sensors 130) implementing the method 400. In some implementations, one or more operations of the method 400 are implemented in computer instructions that, when executed by a processing device, execute the operations of the steps. The method 400 may be performed in the same or a similar manner as described above in regards to method 300.

The method 400 may begin with a setup phase where various blocks 402, 404, 406, 408, and/or 409 are performed to register data that may be used to determine whether a vehicle and/or individual is suspicious. For example, at block 402, law evidence may be registered. The law evidence may be obtained from a system of a law enforcement agency. For example, an application programming interface (API) of the law enforcement system may be exposed and API operations may be executed to obtain the law evidence. The law evidence may indicate whether a person is on a crime watch list 410, whether the person has a warrant, whether person has a criminal record, and/or the Wi-Fi/Bluetooth MAC data (address)/cellular data of electronic devices involved in incidents, as well as the owner data 412 of the electronic devices. The crime watch list 410 information may be used to store crime watch list 414 in a database (e.g., personal identification database 119).

At block 404, license plate registration (LPR) data may be collected using the one or more cameras 120 in the license plate detection zones 122 as LPR raw data 416. The LPR raw data 416 may be used to obtain vehicle owner information (e.g., name, address, phone number, email address) and vehicle information (e.g., license plate ID, make, model, color, year, etc.). For example, the LPR raw data 416 may include at least the license plate ID, which may be used to search the Department of Motor Vehicles (DMV) to obtain the vehicle owner information and/or vehicle information. In some instances, the LPR raw data 416 may be collected from manual entry. At block 406, Wi-Fi MAC addresses may be collected from various sources as Wi-Fi MAC raw data 418. For example, the Wi-Fi MAC raw data 418 may be collected from the electronic device identification sensors 130 in the electronic device detection zones 132. In some instances, trusted Wi-Fi MAC addresses may be manually obtained from certain people owning electronic devices in an area covered by the electronic device detection zones 132 and stored in a database (e.g., personal identification database 119). In some implementations, cellular raw data (e.g., cellular MAC addresses) may be collected from electronic device identification sensors 130. At block 408, Bluetooth MAC addresses may be collected from various sources as Bluetooth MAC raw data 420. For example, the Bluetooth MAC raw data 420 may be collected from the electronic device identification sensors 130 in the electronic device detection zones 132. In some instances, trusted Bluetooth MAC addresses may be manually obtained from certain people owning electronic devices in an area covered by the electronic device detection zones 132 and stored in a database (e.g., personal identification database 119). In some implementations, the Bluetooth MAC addresses may be collected from the electronic device identification sensors 130 at the electronic device detection zones 132. At block 409, face images may be collected as face raw data 421 by the one or more cameras 120 in the facial detection zones 150. Facial recognition may be performed to detect and recognize faces in the face images.

At block 422, the LPR raw data 416, the Wi-Fi MAC raw data 418, the Bluetooth MAC raw data 420, the cellular raw data, and/or the face raw data 421 may be correlated or paired to generate matched data 424. That is, the data from license plate ID detection, LPR systems, personal electronic device detection, and/or facial information may be combined to generate matched data 424 and stored in the database 117 of trusted vehicle license plate IDs and/or the personal identification database 119. In some implementations, the license plate IDs are compared to the personal identification database 119 of trusted vehicle license plate IDs to determine whether the detected license plate ID is in the database 117 of trusted vehicle license plate IDs. If not, the vehicle 126 may be identified as a suspicious vehicle and the license plate ID of the vehicle may be correlated with at least one of the set of stored electronic device IDs 133. This may result in creation of a database of detected electronic device identifiers 133 correlated with license plate IDs and facial information of individuals. Any unpaired data may be discarded after unsuccessful pairing.

At block 426, owner data of the electronic devices and/or vehicle may be added to the matched data 424. The owner data may include an owner ID, and/or name, address, and the like. Further, at block 428, owner's phone number and email may be added to the matched data. In addition, Wi-Fi/Bluetooth MAC/cellular data and owner data 412 from the law evidence may be included with the matched data 424 and the personal information of the owner to generate matched data with owner information 430. Accordingly, the owner ID may be associated with combined personal information (e.g., name, address, phone number, email, etc.), vehicle information (e.g., license plate ID, make, model, color, year, vehicle owner information, etc.), and electronic device IDs 133 (e.g., Wi-Fi MAC address, Bluetooth MAC adder). At block 432, the matched data with owner information 430 may be further processed (e.g., formatted, edited, etc.) to generate matchable data. This may conclude the setup phase.

Next, the method 400 may include a monitoring phase. During this phase, the method 400 may include blocks 442, 444, and 445. At block 442, Wi-Fi MAC address monitoring may include one or more electronic device identification sensors 130 detecting and storing a set of Wi-Fi MAC addresses as Wi-Fi MAC raw data 448. In some implementations, cellular signal monitoring may include one or more electronic device identification sensors 130 detecting and storing a set of cellular MAC addresses as cellular raw data. At block 444, Bluetooth MAC address monitoring may include one or more electronic device identification sensors 130 detecting and storing a set of Bluetooth MAC addresses as Bluetooth MAC raw data 450. At block 445, face monitoring may include the one or more cameras 120 capturing face images and recognizing faces in the face images as face raw data 451. The Wi-Fi MAC raw data 448, Bluetooth MAC raw data 450, and/or face raw data 451 may be compared to matchable data at block 452.

At block 452, the electronic device IDs 133 and/or faces detected by the electronic device identification sensors 130 and/or the cameras 120 may be compared to the matchable data. The matchable data may include personal identification information that is retrieved from at least the personal identification database 119. That is, the detected electronic device IDs 133 and/or faces may be compared to the database 117 of trusted vehicle license plate IDs and/or the personal identification database 119 to find any correlation of the detected electronic device IDs 133 and/or faces with license plate IDs.

If there is a matching electronic device ID to the detected electronic device ID and/or a matching face to the detected face, and there is a correlation with a license plate ID in the database 117 of trusted vehicle license plate IDs and/or the personal identification database 119, then a suspicious vehicle 126/individual 143 may be detected. At block 456, the detected match event may be logged. At block 454, the user interface of the client application 104 executing on the computing device 102 may present an alert of the suspicious vehicle 126/individual 142. At block 456, the detected notification event may be logged. At block 458, the electronic device 140 of the suspicious individual 142 may be notified that his presence is known (e.g., taunted). At block 456, the taunting event may be logged.

At decision block 460, the crime watch list 414 may be used to determine if the identified individual 142 is on the crime watch list 414 using the individual's personal information. If the individual 142 is on the watch list 414, then at block 462, the appropriate law enforcement agency may be notified. At block 456, the law enforcement agency notification event may be logged.

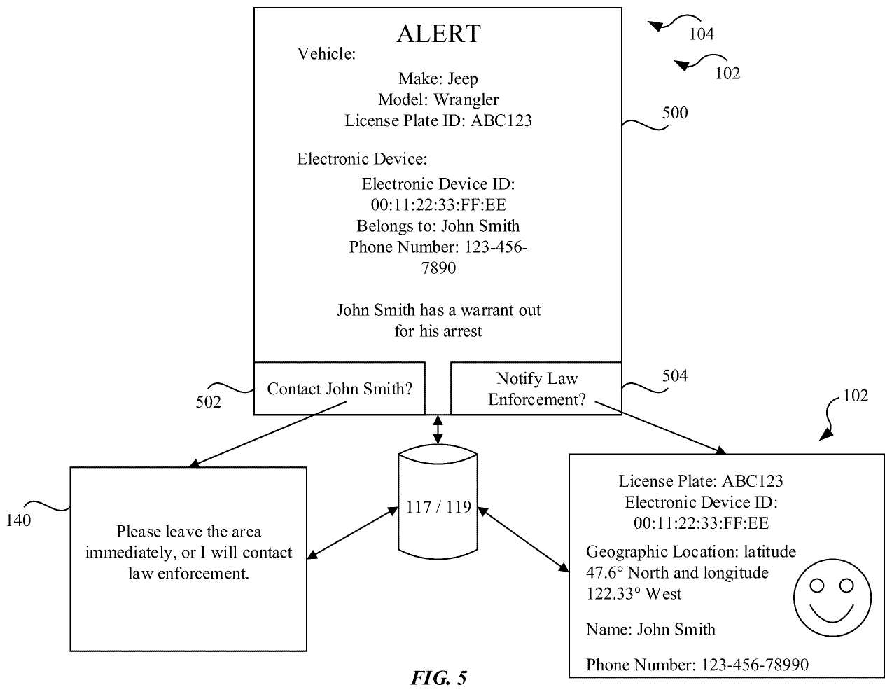

FIG. 5 illustrates example use interfaces presented on computing devices during monitoring vehicle traffic, according to certain implementations of the present disclosure. It should be noted that a user interface 500 may present vehicle information and electronic device information in a single user interface. When a suspicious vehicle 126/individual 142 is detected based on the vehicle license plate ID and/or the electronic device IDs 133, a notification may be presented on the user interface 500 of the client application 104 executing on the computing device 102 of a user (e.g., homeowner, neighbor, interested citizen). As depicted, the notification includes an alert displaying vehicle information and electronic device information. The vehicle information includes the “Make: Jeep”, “Model: Wrangler”, “License Plate ID: ABC123.” The electronic device information includes “Electronic Device ID: 00:11:22:33:FF:EE”, “Belongs to: John Smith”, “Phone Number: 123-456-7890.” Further, the user interface 500 presents that the owner has a warrant out for his arrest. The notification event may be logged in the database 117/119 or any suitable database of the system architecture 100.

The user interface 500 includes various preventative action options represented by user interface clement 502 and 504. For example, user interface element 502 may be associated with contacting the detected suspicious individual 142 directly. Upon selection of the user interface element 502, the user may be able to send a text message to the electronic device 140 of the suspicious individual 142. For example, the text message may read “Please leave the area immediately, or I will contact law enforcement.” However, any suitable message may be sent. The message/taunting event may be logged in the database 117/119 or any suitable database of the system architecture 100.

Since the suspicious individual 142 has a warrant out for his arrest and/or is on a crime watch list, the user interface element 504 may be displayed that provides the option to notify law enforcement. Upon selection of the user interface element 504, a notification may be transmitted to a computing device 102 of a law enforcement agency. The notification may include vehicle information (e.g., “License Plate ID: ABC123”), electronic device information (e.g., “Electronic Device ID: 00:11:22:33:FF:EE”), as well as location of the detection (e.g., “Geographic Location: latitude 47.6° North and longitude 122.33° West”), and personal information (“Name: John Smith”, “Phone Number: 123-456-7890”, a face of the individual 142). The law enforcement agency event may be logged in the database 117/119 or any suitable database of the system architecture 100.

Below are example data tables that may be used to implement the system and method for monitoring vehicle traffic disclosed herein. The data tables may include: Client and ID Tables (logID, loginAttempts, clientUser, lawUser, billing), Data Site Info (monitoredSites, dataSites, dataGroups), Raw Collection Data (rawWiFiDataFound, rawBTDataFound, rawLPRDataFound, pairedData), Monitor Data Raw & Matched (monWiFiDataDetected, monBTDataDetected, monWiFiDataMatched, monBTDataMatched), Subject Data (subjectMatch, subjectInfo, subjectLastSeen, criminalWatchList), Notification Logs (subNotifyLog, subNotifyReplyLog, clientNotifyLog).

TABLE 1
loginID
loginID
username
clientID
idType
rights
email
password
lastLogin

Table 1: logID is used for login ID/passwords, authentication and password resets

TABLE 2
loginAttempts
loginAttempts
clientID
username
timeStamp
IP
wifiRSSI
wifiVendor
wifiLocDet
scanInt

Table 2: loginAttempts logs the number of times logins were attempted for both successes and failures

TABLE 3
clientUser
clientUser
clientID
username
firstName
lastName
phone1
phone2
phone3
email1
email2
email3
txt1
txt2
txt3
lastUserName
dataIDs
lawID
monID

Table 3: clientUser includes information for each user.

TABLE 4
lawUser
lawUser
lawUserName
lawID
lawType
lawPrecinct
lawDept
firstName
lastName
phone1
phone2
phone3
email1
email2
email3
txt1
txt2
Txt3
alertType

Table 4: lawUser includes information for law enforcement persononel wanting to be notified of suspicious vehicles 126/individuals 142.

TABLE 5
billing
billing
clientID
username
package
numMons
options
cardType
cardName
cardAddr1
cardAddr2
cardCity
cardState
cardZIP
cardNum
cardExp
cardID

Table 5: billing may be used for third-party billing.

TABLE 6
monitoredSites
monitoredSites
monID
monGroupID
clientID
monAddr1
monAddr2
monCity
monState
monZIP
monCountry

Table 6: monitoredSites includes information for WiFi/Bluetooth monitoring for detection, among other things.

TABLE 7
dataSites
dataSites
dataID
dataAddr1
dataAddr2
dataCity
dataState
dataZIP
dataCountry
groupNum
hwModel
hwSerialNum
softVersion
installDate
devLoc
notes

Table 7: dataSites includes information for WiFi/Bluetooth/License Plate Registration detection sites. These sites may supply data to databases, among other things.

TABLE 8
dataGroups
dataGroups
groupID
groupName
groupLocation
groupAddr1
groupAddr2
groupCity
groupState
groupZIP
groupCountry
info

Table 8: dataGroups may group data groups and monitored sites. Groupings such as Homeowner Associations, neighborhoods, etc.

TABLE 9
rawWiFiDataFound
rawWiFiDataFound

timeStamp
wifiSync
wifiMAC
wifiDevice
wifiRSSI
wifiVendor
wifiLocDet
scanInt

Table 9: raw WiFiDataFound includes raw data dump for WiFi from detection sites used to look for matches.

TABLE 10
rawBTDataFound
rawBTDataFound

timeStamp
btSync
btMAC
btName
btRSSI
btVendor
btCOD
btLocDet
scanInt

Table 10: rawBTDataFound includes raw data dump for Bluetooth from detection sites used to look for matches.

TABLE 11
rawLPRDataFound
rawLPRDataFound

| | |
|---|---|
| timeStamp | lprPic3 |
| lprPlate | lprPic4 |
| lprState | lprPic5 |
| lpreMake | lprPic6 |
| lprModel | lprPic7 |
| lprPlatePic | lprPic8 |
| lprPic1 | lprLocDet |
| lprPic2 | scanInt |

Table 11: rawLPRDataFound may include raw LPR data from detection sites used to look for matches.

TABLE 12
pairedData
pairedData

| | |
|---|---|
| pairedID | btCOD |
| timeStamp | wifiLocDet |
| lprTimeStamp | btLocDet |
| wifiTimeStamp | lprLocDet |
| btTimeStamp | lprPlatePic |
| lprPlate | lprPic1 |
| lprState | lprPic2 |
| lprMake | lprPic3 |
| lprModel | lprPic4 |
| wifiMAC | lprPic5 |
| wifiDevice | lprPic6 |
| wifiVendor | lprPic7 |
| btMAC | lprPic8 |
| btName | subjectID |
| btVendor | |

Table 12: pairedData includes matched data that may be the correlation between vehicle information (e.g., license plate IDs) and electronic device IDs 133.

TABLE 13
monWiFiDataDetected
monWiFiDataDetected

timestamp
wifiSync
wifiMAC
wifiDevice
wifiRSSI
wifiVendor
wifiMonLoc

Table 13: monWiFiDataDetected logs of any MAC address data detefcted before matching for WiFi.

TABLE 14
monBTDataDetected
monBTDataDetected

timestamp
btSync
btMAC
btName
btRSSI
btVendor
btCOD

Table 14: monBTDataDetected logs of any MAC address data detected before matching for Bluetooth.

TABLE 15
monWiFiDataMatched
monWiFiDataMatched

pairedID
timestamp
wifiSync
wifiMAC
wifiDevice
wifiRSSI
wifiVendor
wifiMonLoc

Table 15: monWiFiDataMatched logs of any matches moniroted sites find on the database for WiFi.

TABLE 16
monBTDataMatched
monBTDataMatched

pairedID
timestamp
btSync
btMAC
btName
btRSSI
btVendor
btCOD
btMonLoc

Table 16: monBTDataMatched logs of any matches monitored sites find on the database for Bluetooth.

TABLE 17
subjectMatch
subjectMatch

subjectID
subjectWiFiMAC
subjectBtMAC
timeStamp

Table 17: subjectMatch includes a number of times subject detected in monitored sites and data sites.

TABLE 18
subjectInfo
subjectInfo

| | |
|---|---|
| subjectID | subPhone1 |
| subFirstName | subPhone2 |
| subLastName | subPhone3 |
| subDOB | subPhone4 |
| subAddr1 | subPhone5 |
| subAddr2 | subPhone6 |
| subCity | subTxt1 |
| subState | subTxt2 |
| subZIP | subTxt3 |

Table 18: subjectInfo includes information obtained for owner of license vehicle.

TABLE 19
subjectLastSeen
subjectLastSeen

pairedID
timestamp
subjectID
locID
monID

Table 19: subjectLastSeen includes locations where subject was seen with a timestamp.

TABLE 20
criminalWatchList
criminalWatchList

subjectID
crimeType
dateCommitted
notifyIfDetected
status

Table 20: criminalWatchList includes a criminal watch list that is compared to subjects/individuals 142 to determine if they are a criminal and who to notify if found.

TABLE 21
subNotifyLog
subNotifyLog

timestamp
clientID
subjectID
subPhoneTexted
msgSent
msgStatus

Table 21: subNotifyLog includes notifications sent to the subject to discourage crime.

TABLE 22
subNotifyReplyLog
subNotifyReplyLog

timestamp
clientID
subjectID
subPhoneTexted
msgReceived

Table 22: subNotifyReplyLog includes any replies from the subject after notification.

TABLE 23
clientNotifyLog
clientNotifyLog

timestamp
clientID
msgSent
msgStatus
msgType
numSent
emailSent

Table 23: clientNotifyLog includes log of notification attempts to the client (e.g., computing device 102 of a user).

Video surveillance is often employed to monitor homes and other types of real estate properties. “Real estate property” shall refer to structures, curtilage, pathways, other areas located within property boundary lines, or a combination thereof. “Real estate property” shall also include commercial real estate, residential real estate, or both. One use case of video surveillance is to detect and send notifications when an individual enters a real estate property. Such notifications may allow interested parties to take appropriate actions, such as contacting law enforcement. An interested party may be, without limitation, an individual, an organization, a software application, a bot, an artificial intelligence engine, or the like. In relation to a real estate property, the term “entering” shall refer to any attempt, whether successful or not, to enter any part of the real estate property or an area proximate to, but located outside of, the property boundary lines of the real estate property. Some non-limiting examples of entering a real estate property include opening a gate, attempting to open a gate, climbing over a fence, attempting to climb over a fence, digging a tunnel underground into the property, entering via sewer or other underground lines or channels, hand gliding onto or near to, parachuting onto or near to, or otherwise entering the property from above ground level, and entering a sidewalk located next to a real estate property. “Individual” shall refer to human beings, non-human animals (e.g., a dog, a mountain lion, a coyote, etc.), or both.

Some conventional video surveillance systems automatically provide notifications for all movement detected in video feeds. Other conventional video surveillance systems automatically provide notifications for all human presence detected in video feeds. However, these systems of automatic notification generally provide a surfeit of notifications, causing most users to disable notifications due to the annoyance of false alarms or similar causes. Intelligent automatic notification of suspicious individuals using video surveillance presents various technical problems. One technical problem exists with accurately identifying individuals in video surveillance feeds. For example, a video surveillance system may mistakenly identify a law-abiding citizen as a wanted criminal listed who is listed in a law enforcement database.

In some implementations, the present disclosure provides one or more technical solutions to the aforementioned technical problems. The present disclosure provides systems and methods for automatic suspicious individual notifications that match individuals entering a real estate property to individuals listed in a database of suspicious individuals (DSI). Identifiers of an individual entering a real estate property may be obtained and used to attempt to match the individual to a person in the DSI. Identifiers of an individual entering a real estate property may be determined using various techniques. For example, identifiers may be received via the cameras 120 in the facial detection zone 150, the electronic device identification sensors 130 in the electronic device detection zone 132-2, the cameras 120 in the license plate detection zone 122, the electronic device identification sensors 130 in the electronic device detection zone 132-1, or a combination thereof. Without limitation, this type of detection can also be used to determine if an individual not otherwise prohibited from entering a property belongs to a suspicious or potentially dangerous class of persons, e.g., ex-felons, in which case the individual should be prohibited from entering or other protective measures should be activated, e.g., calling security. Non-limiting examples for which the last-specified scenario may apply include those involving visitors to an open house of a property for sale or rent, visitors to a commercial or retail business, visitors to a public or private event, and the like.

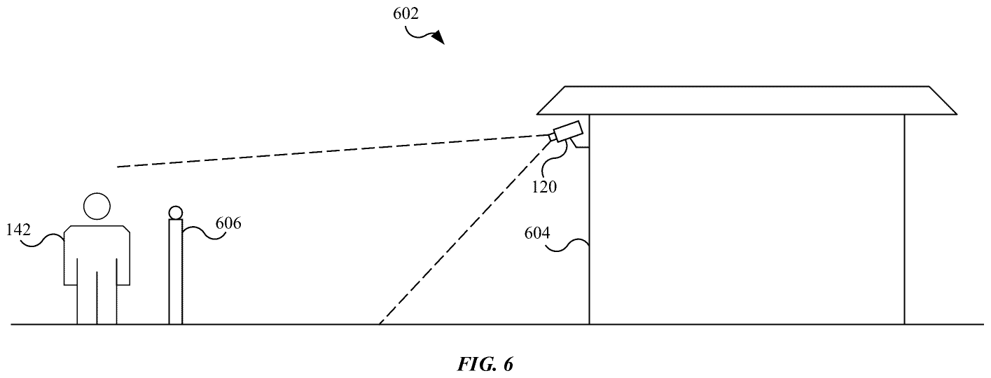

FIG. 6 illustrates an example of a real estate property 602 including, among other things, a structure 604 (e.g., a house, a warehouse, an office space, etc.) and a fence 606. The real estate property 602 may include other structures, curtilage, and pathways that, for brevity, are not illustrated or described in detail. The fence 606 partially defines a border of the real estate property 602. A camera 120 is attached to the structure 604 and is positioned to generate a video feed of a field of view that includes the fence 606. Although a single instance of the camera 120 is illustrated in FIG. 6, biometric identifiers can be determined from video feeds of multiple cameras. Upon entering the real estate property, the individual 142 is visible in the video feed of the camera 120. The video feed of the camera 120 may be used to determine biometric identifiers of the individual 142 such as, but not limited to, facial features, iris-or retinal-based identifiers, fingerprints, gait and potentially unique body features (e.g., tattoos, scars, injuries, deformities, etc.). The video feed of the camera 120 may also be used to determine license plate information or a description of a vehicle associated with the individual 142. The video feed of the camera 120 may further be used to determine non-biometric indicia associated with the individual 142. For example, the video feed of the camera 120 may be used to detect a company name or logo displayed on a piece of clothing worn by the individual 142 or, more generally, the color of any particular piece of clothing worn by the individual 142, wherein clothing worn includes any type of hat, cap or the like.

In some implementations, an individual entering a real estate property may be identified using the individual's electronic devices. For example, the electronic device identification sensors 130 may determine electronic identifiers of electronic devices located proximate to the individual. The term “proximate,” as used herein, may refer, without limitation, to measures of distance, a presence within a predefined area, changes in distance that are substantially significant, nearness in space, time, or relationship, etc. Electronic devices may include smartphones, tablets, laptops, key fobs, radio frequency identification (RFID) devices, and wearable electronic devices. For example, the electronic device identification sensors 130 may detect an electronic identifier of a smartphone located in a pocket of an individual entering a real estate property. Electronic identifiers of a smartphone may include Bluetooth MAC addresses, Wi-Fi MAC addresses, cellular MAC addresses, IMEIs (International Mobile Equipment Identities), IDFAs (Apple IDs for Advertisers), and GAIDs (Google Advertising IDs). The electronic device identification sensors 130 may also detect an electronic identifier of a vehicle associated with an individual entering a real estate property. Electronic identifiers of a vehicle may include a Wi-Fi access point address, a telematics system identifier, and a toll tag.

In real-world systems, identifying individuals with video surveillance may produce results with varying degrees of confidence. For example, a video surveillance system may not be able to capture an individual's entire face, and thus, may identify the individual based on only a partial facial comparison. Using low, fixed probability thresholds to identify individuals may result in an abundance of type I errors in statistics (e.g., false positives). Further, using high, fixed probability thresholds to identify individuals may result in an abundance of type II errors in statistics (e.g., false negatives). The present disclosure enables intelligent suspicious individual notification by using variable probability thresholds to match individuals entering a real estate property with individuals listed in the DSI. The probability thresholds used to identify high-risk individuals in the DSI are lower than the probability thresholds used to identify low-risk individuals in the DSI. For example, the probability threshold used to identify a person in the database with an active warrant for a violent crime is lower than the probability threshold used to identify a person in the database that has been charged with check-kiting (although, in the case of a retail establishment, the weighting system could be different).

In some implementations, the DSI may include criminals. As used herein, “criminals” include, without limitation, convicts, ex-convicts, persons released from prison or jail who are on bail or probation and/or who are subject to restrictions such as house arrest and/or electronic monitoring, persons suspected of or indicted for crimes, persons on governmental watch lists (e.g., terrorism), persons associating with other individuals who are themselves criminals, persons with outstanding warrants, persons identified in an all-points bulletin, persons who are the subject of existing or prior restraining orders, persons on sex offender registries, persons who are subject to a subpoena other than as an innocent witness or regarding unrelated civil matters, persons in contempt of court, and the like. In some implementations, the DSI may include an alias or a street name for an individual whose actual identity may be unknown.

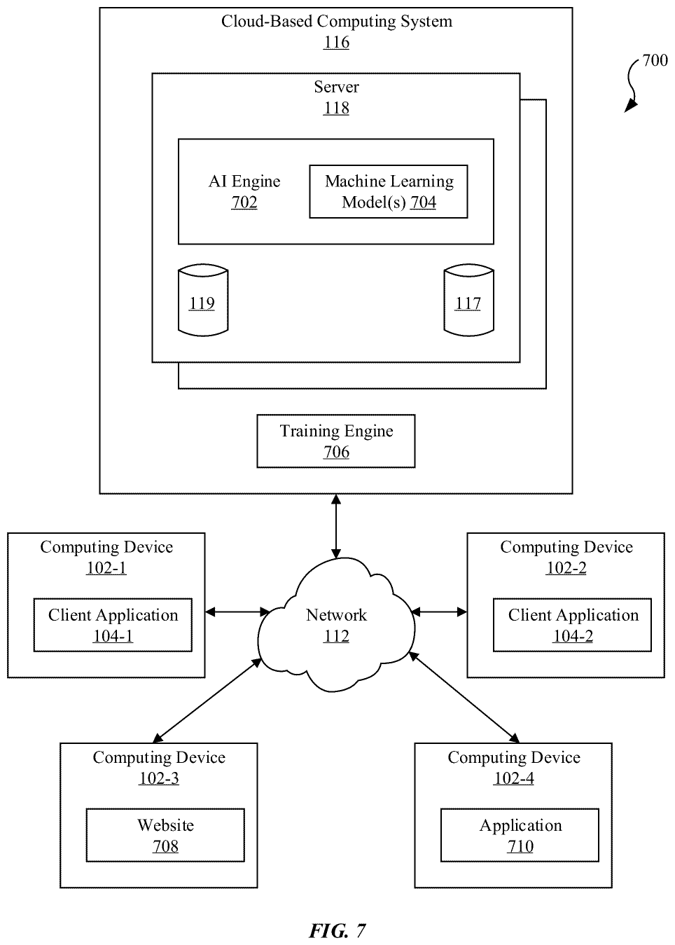

FIG. 7 illustrates another high-level component diagram of an example of a system architecture 700, according to certain implementations of the present disclosure. In some implementations, the system architecture 700 may include the cloud-based computing system 116, and computing devices 102-1, 102-2, 102-3, and 102-4 communicatively coupled via the network 112. The cloud-based computing system 116 may be a real-time software platform, include privacy software or protocols, or include security software or protocols. Each of the computing devices 102-1, 102-2, 102-3, and 102-4 and the components included in the cloud-based computing system 116 may include one or more processing devices, memory devices, and/or network interface cards.

The network interface cards may enable communication via a wireless protocol for transmitting data over short distances, such as Bluetooth, ZigBee, NFC, etc. Additionally, the network interface cards may enable communicating data via a wired protocol over short or long distances, and in one example, the computing devices 102-1, 102-2, 102-3, and 102-4 and/or the cloud-based computing system 116 may communicate with the network 112. The network 112 may be a public network (e.g., connected to the Internet via wired (Ethernet) or wireless (Wi-Fi)) connections, a private network (e.g., a local area network (LAN) or wide area network (WAN)), or a combination thereof. In some implementations, the network 112 may also comprise a node or nodes on the Internet of Things (IoT).

In some implementations, the cloud-based computing system 116 may include one or more servers 118 that form a distributed computing system, which may include a cloud computing system. The servers 118 may be a rackmount server, a router, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 118 may include one or more processing devices, memory devices, data storage, or network interface cards. The servers 118 may be in communication with one another via any suitable communication protocol. The servers 118 may execute an artificial intelligence (AI) engine 702 and one or more machine learning models 704, as described further herein.

That is, the servers 118 may execute an AI engine 702 that uses one or more machine learning models 704 to perform at least one of the embodiments disclosed herein. The cloud-based computing system 116 may also include the database 117 of trusted vehicle IDS and/or the personal identification database 119 that may store data, knowledge, and data structures used to perform various embodiments. For example, the database 117 of trusted vehicle license plate IDs and/or the personal identification database 119 may store user profiles that include information pertaining to suspicious individuals (e.g., personally identifiable information, criminal records, employment records, etc.). The database 117 of trusted vehicle license plate IDs and/or the personal identification database 119 may also store information pertaining to crime statistics associated with certain locations, traffic patterns, weather patterns, event schedules, and the like. Although depicted as part of the servers 118, in some implementations, the database 117 of trusted vehicle license plate IDs and/or the personal identification database 119 may be deployed separately from the servers 118.

In some implementations, the cloud-based computing system 116 may include a training engine 706 configured to generate machine learning models 704. Although depicted separately from the AI engine 702 in FIG. 7, the training engine 706 may, in some implementations, be included in the Al engine 702 executing on the server 118. In some implementations, the AI engine 702 may use the training engine 706 to generate the machine learning models 704 trained to perform inferencing and/or predicting operations, among other things. The one or more machine learning models 704 may be generated by the training engine 706 and may be implemented in computer instructions executable by one or more processing devices of the training engine 706 or the server 118. To generate the one or more machine learning models 704, the training engine 706 may train the one or more machine learning models 704. The one or more machine learning models 704 may be used by any of the methods described herein.

The training engine 706 may be a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 706 may, without limitation, be cloud-based or a real-time software platform, and the training engine may also include privacy software or protocols, or security software or protocols.

To generate the one or more machine learning models 704, the training engine 706 may train the one or more machine learning models 704. In some implementations, the training engine 706 may use a base training data set including inputs of labeled data mapped to labeled outputs. The one or more machine learning models 704 may refer to model artifacts created by the training engine 706 wherein the training engine 706 uses training data that includes training inputs and corresponding target outputs. The training engine 706 may find patterns in the training data wherein such patterns map the training input to the target output and generate the machine learning models 704 that capture these patterns. In some implementations, the AI engine 702, the database 117 of trusted vehicle license plate IDs and/or the personal identification database 119, and/or the training engine 706 may reside on any of the computing devices 102-1, 102-2, 102-3, and 102-4.

As described in more detail below, the one or more machine learning models 704 may comprise, for example, a single level of linear or non-linear operations (e.g., a support vector machine (SVM)) or the machine learning models 704 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons as well as to itself). For example, the machine learning model may include numerous layers or hidden layers that perform calculations (e.g., dot products) using various neurons. In some implementations, the one or more machine learning models 704 may be trained via supervised learning, unsupervised learning, and/or reinforcement learning.

The term “supervised learning,” when used in a machine learning context, may refer to a technique that uses labeled datasets to train algorithms to classify data or predict outcomes accurately. Labeled input data may be provided to a machine learning model that adjusts its weights and/or other parameters until the machine learning model is trained to properly identify labeled outputs. The algorithm measures the machine learning model's accuracy through a loss function by adjusting the weights and/or parameters until an error satisfies a threshold level.

The term “unsupervised learning,” when used in a machine learning context, may refer to a technique that, based on similarities and/or differences among the datasets, analyzes and clusters unlabeled datasets by identifying patterns or data groupings in the datasets. One example of unsupervised learning includes clustering. Clustering may refer to a data mining technique that groups unlabeled data based on the similarities or differences within different parts of the unlabeled data. Another example of unsupervised learning comprises association rules. Association rules may refer to a rule-based method for finding relationships between variables in a given dataset. Another example of unsupervised learning comprises dimensionality reduction. Dimensionality reduction may refer to a technique used when the number of features, or dimensions, in a dataset is too high. Dimensionality reduction reduces the number of data inputs to a manageable size while maintaining the integrity of the dataset.

The term “reinforcement learning,” when used in a machine learning context, may refer to a technique that enables an agent to learn in an interactive environment via trial and error by using feedback from its own actions and experiences. Reinforcement learning uses rewards and punishments as signals to indicate, during the training phase of a machine learning model, positive and negative behaviors of the agent. One salient goal of reinforcement learning is to discover a suitable machine learning model that maximizes the total cumulative reward of or associated with the agent.

In some implementations, one or more machine learning models may be generated and trained by the AI engine 702 and/or the training engine 706 to perform one or more of the operations of the methods described herein. For example, to perform the one or more operations, the processing device may execute the one or more machine learning models 704. In some implementations, the one or more machine learning models 704 may be iteratively retrained to select different features capable of enabling optimization of output. The features that may be modified may include a number of nodes included in each layer of the machine learning models 704, an objective function executed at each node, a number of layers, various weights associated with outputs of each node, and the like.

In some implementations, the server 118 may analyze various individual identifiers (e.g., biometric identifiers and electronic identifiers) of a set of individuals in the DSI and output recommended matches for an individual entering a real estate property. The server 118 may further provide indications of the strengths of each recommended match. The server 118 may execute a machine learning model 704 trained to output a recommended match and a strength of the recommended match. The training engine 706 may train the machine learning model 704 using training data including labeled inputs (e.g., faces, fingerprints, gait, license plate information, etc.) mapped to labeled outputs (e.g., match recommendations and strengths of the match recommendations).

The computing devices 102-1, 102-2, 102-3, and 102-4 may be any suitable computing device, such as an embedded computer device with display, a laptop, tablet, smartphone, smartwatch, an IoT device, or computer. The computing devices 102-1, 102-2, 102-3, and 102-4 may include a display capable of presenting a user interface of a client application 104-1 and 104-2, a website 708 (e.g., social networking website, online marketplace website, organization website, company website, content sharing website, chat forum website, gaming website, etc.), and/or an application 710 (e.g., messaging application, gaming application, etc.). The client application 104-1 and 104-2, the website 708, and/or the application 710 may be implemented in computer instructions stored on the one or more memory devices and executable by the one or more processing devices.

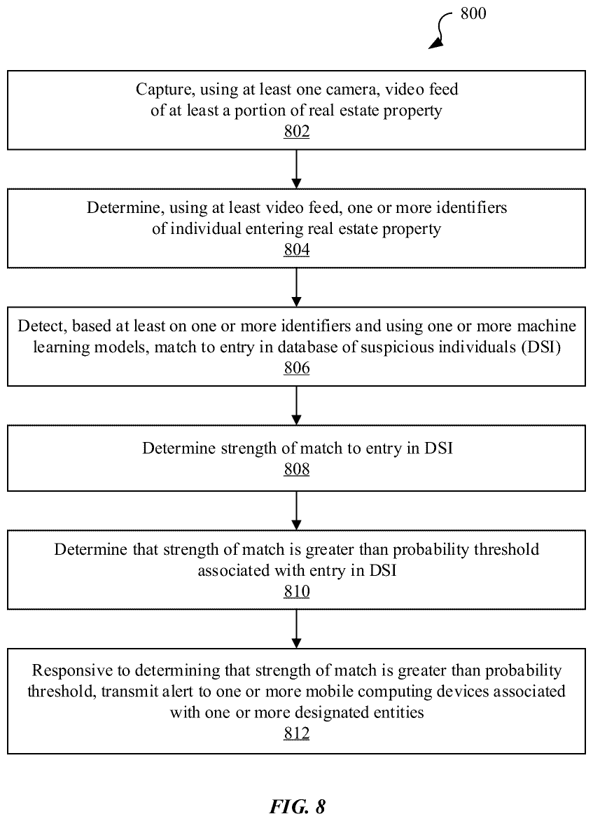

FIG. 8 illustrates an example of a method 800 for providing notification of suspicious individuals entering real estate properties, according to certain implementations of the present disclosure. The method 800 may be performed by processing logic that may include hardware (circuitry, dedicated logic, etc.), firmware, software (such as is run on a computer system or specialized dedicated machine), or a combination of both. The method 800 and/or each of their individual functions, subroutines, methods (as the term is used in object-oriented programming), or operations may be performed by one or more processing devices of one or more of the devices in FIG. 1A and/or FIG. 7 (e.g., computing device 102-1, computing device 102-2, computing device 102-3, computing device 102-4, cameras 120, electronic device identification sensors 130, computing device 161, cloud-based computing system 116 including servers 118) implementing the method 800. For example, a computing system may refer to the computing device 102 or the cloud-based computing system 116. The method 800 may be implemented as computer instructions that, when executed by a processing device, execute the operations. In some implementations, the method 800 may be performed by a single processing thread. Alternatively, the method 800 may be performed by two or more processing threads, each thread implementing one or more individual functions, routines, subroutines, methods (as the term is used in object-oriented programming), or operations of the method 800.

For simplicity of explanation, the method 800 is depicted and described as a series of operations. However, operations in accordance with this disclosure can occur in various orders or concurrently, and with other operations not presented and described herein. For example, the operations depicted in the method 800 may occur in combination with any other operation of any other method disclosed herein. Furthermore, not all illustrated operations may be required to implement the method 800 in accordance with the disclosed subject matter. In addition, those skilled in the art will understand and appreciate that the method 800 could alternatively be represented as a series of interrelated states via a state diagram or events.

In some implementations, one or more machine learning models 704 may be generated and trained by the AI engine 702 and/or the training engine 706 to perform one or more of the operations of the methods described herein. For example, to perform the one or more operations, the server 118 may execute the one or more machine learning models 704. In some implementations, the one or more machine learning models 704 may be iteratively retrained to select different features capable of enabling optimization of output. The features that may be modified may include a number of nodes included in each layer of the machine learning models 704, an objective function executed at each node, a number of layers, various weights associated with outputs of each node, and the like.

At block 802, the processing device may capture, using at least one camera 120, a video feed of at least a portion of a real estate property. At block 804, the processing device may determine, using at least the video feed, one or more identifiers of an individual entering the real estate property. For example, the cameras 120 may capture facial features of the individual, the cameras 120 may capture images of the individual's fingerprints, the electronic device identification sensors 130 may determine a cellular MAC address of a smartphone being carried by the individual, and the cameras 120 may capture an identification number on a parking sticker attached to a vehicle driven by the individual.

At block 806, the processing device may detect, based at least on the one or more identifiers and by using one or more machine learning models 704, a match to an entry in the DSI. As a simple example, the processing device may match facial features captured by the cameras 120 to facial profiles in the DSI. As a further example, the processing device may match license plate information captured by the cameras 120 to vehicle records in the DSI. The processing device may match one type of identifier or a plurality of different identifiers to the DSI.

At block 808, the processing device may determine a strength of the match to the entry in the DSI. In some implementations, the processing device may determine a score on a fixed scale that indicates the strength of the match. For example, the processing device may correlate different identifier matches to determine a number of a scale from 1 to 100. In some implementations, the one or more machine learning models 704 may determine the strength of the match. For example, the one or more machine learning models 704 may be trained to output a match to an entry in the DSI along with a strength value associated with the match. In some implementations, the processing device may apply different weights to different types of identifiers. For example, the processing device may give greater weight to a facial match than to a tattoo match.

At block 810, the processing device may determine that the strength of the match is greater than a probability threshold associated with the entry in the DSI. As described above, the probability threshold for each entry in the DSI is determined based on the amount of risk associated with each individual. In some implementations, the processing device determines a risk score for each individual in the DSI that indicates the amount of risk associated with each individual. The probability threshold for each individual in the DSI may be inversely related to the risk score. For example, a first individual in the DSI with a first risk score may be associated with a first threshold probability. Further, a second individual in the DSI with a second risk score that is greater than the first risk score may have a second probability threshold that is less than the first probability threshold. An inverse relationship between the probability threshold for each individual in the DSI and the risk may have a correlation coefficient other than −1.00. The inverse relationship may encompass a range of strengths of inversions.

The probability thresholds for individuals in the DSI may be determined based on attributes of the real estate property. In some implementations, the probability thresholds may be determined based on a type of goods stored at the real estate property. For example, for a real estate property that stores jewelry, such as a jewelry store or warehouse, the probability threshold for an individual with a criminal conviction for jewelry theft may be lower (i.e., consistent with the statement above that the probability threshold may be inversely related to the risk score, a lower probability threshold here means that the circumstance is more suspicious, because less of a match is required to indicate a concerning level of risk and to therefore trigger an alarm, warning, notification, and/or other action) than the probability threshold for an individual with a criminal conviction for car theft. As a further example, for a real estate property that stores meat, such as a meat distribution warehouse, the probability threshold for an individual with a history of animal rights activism may be lower than the probability threshold for an individual charged with stealing high-end electronics.

In some embodiments, the probability thresholds may be determined based on a service provided at the real estate property. For example, for a real estate property that provides shelter for abused women, the probability thresholds for an individual charged with domestic violence may be lower than the probability threshold for an individual charged with burglary. As a further example, for a real estate property that provides general residential housing, such as a single family home or a condo building, the probability threshold for an individual charged with burglary may be lower than the probability threshold for an individual charged with financial fraud.

In some embodiments, the probability thresholds may be determined based on an affiliation of the real estate property. Affiliations of the real estate property may include, for example, religious affiliations, political affiliations, financial affiliations, of a combination thereof. For example, for a real estate property with a religious affiliation, such as a church or temple, the probability thresholds for an individual with a history of religiously-based violence may be lower than the probability threshold for an individual with a history of environmental activism. As a further example, for a real estate property with a financial affiliation with an oil refinery company, such as an office of an investment firm, the probability thresholds for an individual with a history of environmental activism may be lower than the probability threshold for an individual with a history of religious activism. An affiliation of a real estate property may also include an affiliation of an owner of the real estate property, an investor in the proper, a member of a partnership or executive or board member of a corporation associated with the property, an occupant of the real estate property, an employee of the real estate property, or a combination thereof. For example, an affiliation of a general book store may be a political affiliation of the owner of the book store. As a further example, an affiliation of the single family home may be a religious affiliation of the occupants of the home.

Returning to FIG. 8, responsive to determining that the strength of the match is greater than the probability threshold, the processing device may transmit an alert to one or more mobile computing devices associated with one or more designated entities at block 812. Designated entities may include, e.g., owners of the real estate property, occupants of the real estate property, an investor in the property, a member of a partnership or executive or board member of a corporation associated with the property employees of the real estate property, or a combination thereof. For example, a manager of a storage facility may receive an alert when a suspicious individual attempts to enter the storage facility. The alert may indicate that a suspicious individual is entering the real estate property. The alert may also may provide information about the suspicious individual (e.g., the suspicious individual's name, whether the suspicious individual is armed, whether the suspicious individual is on a crime watch list, whether the suspicious individual has a criminal record, etc.). The alert may also provide may also provide information about the real estate property (e.g., the street address of the property, a contact number for a phone line located at the real estate property, a description of the real estate property, etc.).

The alert may be transmitted to one or more mobile computing devices associated with the one or more designated entities (e.g., to computing device 102-1, computing device 102-2, computing device 102-3, computing device 102-4, or a combination thereof). The user interfaces of client application 104-1, client application 104-2, website 708, and application 710 may present various screens to a user. The various screens may present various views including graphical user interfaces displaying information about the suspicious individual entering the real estate property, information about the real estate property, one or more video feeds of the real estate property, or a combination thereof. The user interfaces may present several preventative actions for the user. For example, the user may notify law enforcement, contact the suspicious individual (e.g., send a threatening text message), and so forth. In some embodiments, the alert may provide instructions to the user. For example, when the user is located in the real estate property and the suspicious individual presents a potential physical risk to the user, the alert may include instructions to get down, hide, or leave the real estate property.

Using sirens to make an intruder aware that the intruder has been detected may be an effective deterrent. For example, a klaxon may sound to notify an intruder that the intruder has been detected. However, deployment of sirens in a real estate property presents various technical problems. For example, a large quantity of sirens may be necessary to ensure that the entire real estate property is covered. Further, sirens generally require cither frequent battery replacement or costly installation of power supply wires. In some embodiments, the present disclosure provides one or more technical solutions to the aforementioned technical problems. The present disclosure may notify intruders that the intruders have been detected using the intruders' own electronic devices. As described above, an individual entering a real estate property may be identified using their electronic devices. In some embodiments, a warning is transmitted to an electronic device of the individual indicating that the individual should leave the real estate property. Warnings may include audio warnings (e.g., calls with automated messages), visual warnings (e.g., text messages, emergency alerts, pop-up notifications, and emails), or both. In some embodiments, the warning may provide identification information about the individual. For example, the warning may include the name of the individual so that the individual recognizes that the individual has been identified. By utilizing an intruder's own electronic device to notify the intruder that they have been detected, the present disclosure enables use of an effective intruder deterrent without the technical problems associated with the installation and maintenance of conventional sirens. Further, receiving a warning on an intruder's electronic device may provide a higher level of shock to the intruder than light and noise from a siren e.g., “John Doe, we know you have entered 123 Main Street illegally. Leave now or (alternatively, “and”) face immediate arrest and prosecution.”).

In some embodiments, the present disclosure notifies law enforcement when an individual entering a real estate property is wanted by law enforcement. As described above, the DSI may include criminals. The DSI may also indicate whether an individual included in the DSI is wanted by law enforcement. For example, the DSI may indicate that an individual has an outstanding warrant, is on a governmental watch list, is identified in an all-points bulletin, or a combination thereof. Responsive to determining that an individual entering a real estate property is wanted by law enforcement, a notification may be transmitted to one or more law enforcement agencies. Further or alternatively, under certain circumstances, the same notification may be transmitted to one or more private security services authorized to provide security for the real estate property. A notification may include a call to an emergency dispatcher, a submission to an electronic crime reporting system, or a combination thereof. A notification may include videos or photos related to the individual. For example, a notification may include a video feed of the individual captured by the cameras 120. As a further example, a notification may include a mug shot that is included in the DSI. In some embodiments, a notification may be transmitted to the law enforcement agency associated with the wanted status of the individual. For example, a notification may be transmitted to a governmental law enforcement agency when the individual is on a governmental watch list. As a further example, a notification may be transmitted to a local police force when the individual is identified in an all-points bulletin issued by the local police force. Alternatively, or in addition, a notification may be transmitted to one or more law enforcement agencies that are not directly associated with the wanted status of the individual. For example, a notification may be sent to a local police force when the individual is subject to an out-of-state arrest warrant. As a further example, a notification may be sent to a local police force when the individual is on a governmental watch list.

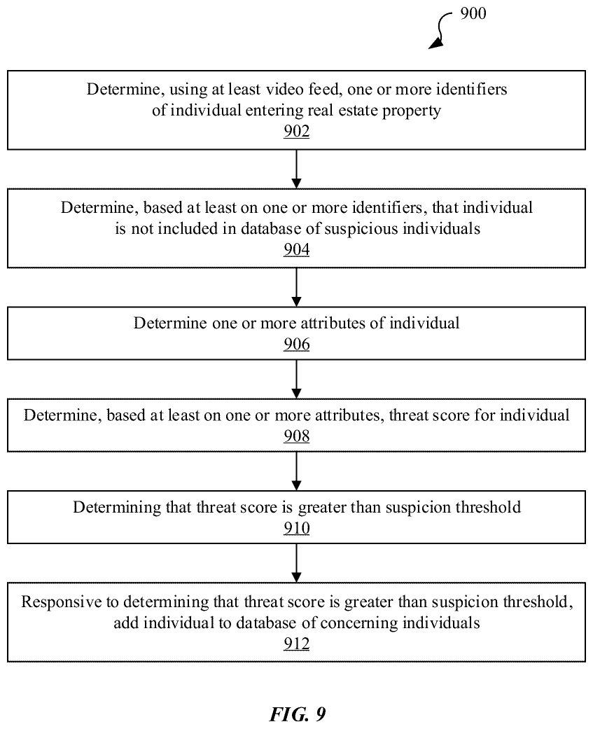

As described above, the DSI may include criminals. In some embodiments, the present disclosure may provide recommendations of non-criminal individuals to add to the DSI. FIG. 9 illustrates an example of a method 900 for recommending individuals to add to the DSI, according to certain embodiments of the present disclosure. The method 900 may be performed by processing logic that may include hardware (circuitry, dedicated logic, etc.), firmware, software (such as is run on a computer system or specialized dedicated machine), or a combination of both. The method 900 and/or each of their individual functions, subroutines, methods (as the term is used in object-oriented programming), or operations may be performed by one or more processing devices of one or more of the devices in FIG. 1A and/or FIG. 7 (e.g., computing device 102-1, computing device 102-2, computing device 102-3, computing device 102-4, cameras 120, electronic device identification sensors 130, computing device 161, cloud-based computing system 116 including servers 118) implementing the method 900. For example, a computing system may refer to the computing device 102 or the cloud-based computing system 116. The method 900 may be implemented as computer instructions that, when executed by a processing device, execute the operations. In some embodiments, the method 900 may be performed by a single processing thread. Alternatively, the method 900 may be performed by two or more processing threads, each thread implementing one or more individual functions, routines, subroutines, methods (as the term is used in object-oriented programming), or operations of the method 900. Method 900 may be performed in a manner similar to method 800.

At block 902, the processing device may determine, using at least the video feed, one or more identifiers of an individual entering the real estate property. At block 904, the processing device may determine, based at least on the one or more identifiers, that the individual is not included in the DSI. For example, the processing device may determine that facial features captured by the cameras 120 do not match any facial profiles in the DSI. In some embodiments, a minimum threshold may be used to exclude very low confidence matches. For example, the processing device may exclude a facial match that is less than 20%.

At block 906, the processing device may determine one or more attributes of the individual. Attributes of an individual entering a real estate property may be determined using various techniques. For example, attributes may be received via the cameras 120 in the facial detection zone 150, the electronic device identification sensors 130 in the electronic device detection zone 132-2, the cameras 120 in the license plate detection zone 122, the electronic device identification sensors 130 in the electronic device detection zone 132-1, or a combination thereof. Attributes of an individual may include possession of a weapon, use of concerning language (e.g., threats and obscenities), displaying symbols or words associated with concerning affinity groups (e.g., hate groups, gangs, terrorists, etc.), or a combination thereof.

At block 908, the processing device may determine, based at least on the one or more attributes, a threat score for the individual. In some embodiments, the processing device may apply different weights to different types of attributes. For example, the processing device may give greater weight to a weapon carried by an individual than to obscene language spoken by the individual. Further, the processing device may apply different weights to different types of similar attributes. For example, the processing device may give greater weight to a firearm carried by an individual than to a bat carried by the individual. In some embodiments, the machine learning models 704 may determine threat scores. For example, the machine learning models 704 may be trained to receive attributes of an individual as input and output a threat score for the individual.

At block 910, the processing device may determine that the threat score is greater than a suspicion threshold. Responsive to determining that the threat score is greater than the suspicion threshold, the processing device may add the individual to a database of concerning individuals (DCI) at block 912. The DCI may be separate from the DSI. The DCI may act as a buffer to allow a user to make the final determination on whether an individual should be added to the DSI. For example, the user may receive a notification when an individual is added to the DCI. The notification may include information regarding potentially concerning attributes of the individual (e.g., possession of a weapon, excessive loitering around the real estate property, etc.). The notification may also include photos and/or a video feed of the individual. The user may respond to the notification with user input that indicates whether or not the individual should be added to the DSI. In some embodiments, the suspicion threshold may be a fixed value. In other embodiments, the suspicion threshold may vary based on, e.g., user responses to notifications of potentially concerning individuals. For example, the suspicion threshold may be lowered when the user rejects a large number of individuals which are identified as potentially concerning.

A database of excluded individuals (DEI) may be used to prevent erroneous concerning individual notifications. In some embodiments, the processing device may not evaluate if an individual included in the DEI is potentially concerning. For example, a security officer at a warehouse may be (but is not required to be, as there could be an “inside job”) included in the DEI so that the security officer is not erroneously identified as potentially concerning for possessing a firearm.

The systems and methods described above relate to providing notification of suspicious people. In addition to providing notification of suspicious people, the present disclosure may provide notification of suspicious animals. In some embodiments, the DSI may include entries for specific dangerous animals. For example, a specific dog with a history of attacking children may be included in the DSI. Alternatively, or in addition, the DSI may include entries for dangerous breeds of animals. For example, a breed of dog with high levels of aggression may be included in the DSI. Alternatively, or in addition, the DSI may include entries for dangerous species of animals. For example, brown bears may be included in the DSI.

In addition to providing notification of suspicious people in and around a real estate property, the present disclosure may provide notification of suspicious people in public spaces. For example, the present disclosure may enable the provision of notifications to relevant users and/or authorities, including law enforcement and private security, of criminals in subways. In addition, given the high correlation of people who jump turnstiles in public transportation networks and people with outstanding warrants, the present disclosure may detect people jumping turnstiles and notify law enforcement and/or private security. As a further example, the preset disclosure may provide notifications of intrusion in restricted areas of a hospital.

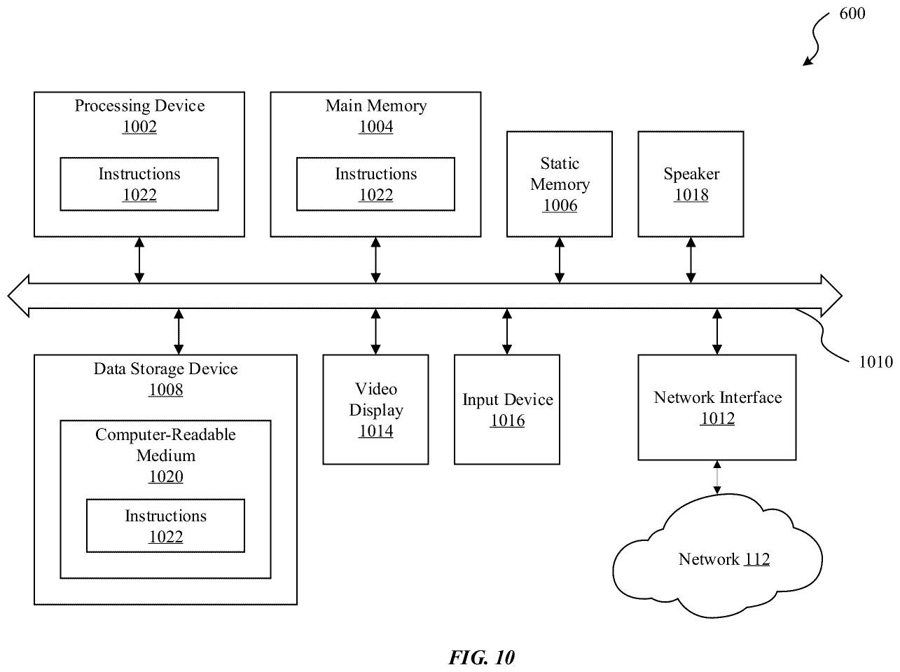

FIG. 10 illustrates an example of a computer system 1000 which can perform any one or more of the methods described herein, in accordance with one or more aspects of the present disclosure. In one example, the computer system 1000 may correspond to the computing device 102 (e.g., 102-1, 102-2, 102-3, 102-4), server 118 of the cloud-based computing system 116, the cameras 120, the electronic device identification sensors 130, the computing device 161, and/or the training engine 706 of FIG. 1A and FIG. 7. The computer system 1000 may be capable of executing client application 104 (e.g., 104-1, 104-2), website 708, and/or application 710 of FIG. 1A and FIG. 7. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a wearable (e.g., wristband, smartwatch, necklace, anklet, etc.), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1000 includes a processing device 1002, a main memory 1004 (e.g., read-only memory (ROM), flash memory, dynamic random access memory (DRAM) such as synchronous DRAM (SDRAM)), a static memory 1006 (e.g., solid state drive (SSD), flash memory, static random access memory (SRAM)), and a data storage device 1008, which communicate with each other via a bus 1010.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions for performing any of the operations and steps discussed herein.

The computer system 1000 may further include a network interface device 1012 communicatively coupled to the network 112. The computer system 1000 also may include a video display 1014 (e.g., a liquid crystal display (LCD) or a cathode ray tube (CRT)), one or more input devices 1016 (e.g., a keyboard and/or a mouse), and one or more speakers 1018 (for example, a speaker). In one illustrative example, the video display 1014 and the input device(s) 1016 may be combined into a single component or device (e.g., an LCD touch screen).

The data storage device 1008 may include a computer-readable medium 1020 on which the instructions 1022 (e.g., implementing control system, user portal, clinical portal, and/or any functions performed by any device and/or component depicted in the FIGs. and described herein) embodying any one or more of the methodologies or functions described herein is stored. The instructions 1022 may also reside, completely or at least partially, within the main memory 1004 and/or within the processing device 1002 during execution thereof by the computer system 1000. As such, the main memory 1004 and the processing device 1002 also constitute computer-readable media. The instructions 1022 may further be transmitted or received over a network 112 via the network interface device 1012.

While the computer-readable medium 1020 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Consistent with the above disclosure, the examples of systems and method enumerated in the following clauses are specifically contemplated and are intended as a non-limiting set of examples.

Clause 1. A computer-implemented method comprising:
capturing, using at least one camera, a video feed of at least a portion of a real estate property;
determining, using at least the video feed, one or more identifiers of an individual entering the real estate property;
detecting, based at least on the one or more identifiers and by using one or more machine learning models, a match to an entry in a database of suspicious individuals (DSI);
determining a strength of the match to the entry in the DSI;
determining that the strength of the match is greater than a probability threshold associated with the entry in the DSI; and
responsive to determining that the strength of the match is above the probability threshold, transmitting an alert to one or more mobile computing devices associated with one or more designated entities.

Clause 2. The computer-implemented method of any clause herein, wherein the one or more identifiers include at least one or more detected biometric identifiers of the individual, and wherein determining, based at least on the one or more identifiers, the strength of the match to the entry in the DSI further comprises comparing the one or more detected biometric identifiers to one or more stored biometric identifiers associated with the entry in the DSI.

Clause 3. The computer-implemented method of any clause herein, wherein the one or more identifiers include at least a detected electronic identifier of an electronic device located proximate to the individual, and wherein determining, based at least on the one or more identifiers, the strength of the match to the entry in the DSI further comprises comparing the detected electronic identifier to a stored electronic identifier associated with the entry in the DSI.

Clause 4. The computer-implemented method of any clause herein, further comprising:
transmitting a warning to the electronic device, wherein the warning indicates that the individual should leave the real estate property.

Clause 5. The computer-implemented method of any clause herein, further comprising:
determining, based on the entry in the DSI, that the individual is wanted by one or more law enforcement agencies; and
responsive to determining that the individual is wanted by the one or more law enforcement agencies, transmitting a notification to at least one of the one or more law enforcement agencies.

Clause 6. The computer-implemented method of any clause herein, further comprising:
determining, based at least on one or more attributes of the real estate property, the probability threshold associated with the entry in the DSI.

Clause 7. The computer-implemented method of any clause herein, wherein the one or more attributes of the real estate property comprise at least one selected from the group consisting of a type of goods stored at the real estate property, a service provided at the real estate property, and an affiliation of the real estate property.

Clause 8. The computer-implemented method of any clause herein, further comprising:
determining a risk score for the entry in the DSI; and
determining, based at least on the risk score, the probability threshold associated with the entry in the DSI,
wherein the probability threshold is inversely related to the risk score.

Clause 9. The computer-implemented method of any clause herein, wherein the entry is a first entry, wherein the probability threshold is a first probability threshold, wherein the DSI further includes at least a second entry associated with a second probability threshold, and wherein the method further comprises:
determining a first risk score for the first entry;
determining, based at least on the first risk score, the first probability threshold;
determining a second risk score for the second entry, wherein the second risk score is greater than the first risk score; and
determining, based at least on the second risk score, the second probability threshold, wherein the second probability threshold is less than the first probability threshold.

Clause 10. The computer-implemented method of any clause herein, wherein the individual is a first individual, wherein the method further comprises:
determining, using at least the video feed, one or more identifiers of a second individual entering the real estate property;
determining, based at least on the one or more identifiers of the second individual, that the second individual is not included in the DSI or in a database of excluded individuals;
determining one or more attributes of the second individual;
determining, based at least on the one or more attributes, a threat score for the second individual;
determining that the threat score is greater than a suspicion threshold; and
responsive to determining that the threat score is greater than the suspicion threshold, adding the second individual to a database of concerning individuals.

Clause 11. A system comprising:
one or more memory devices storing instructions; and
one or more processing devices communicatively coupled to the one or more memory devices, wherein the one or more processing devices are configured to execute the instructions to:
   capture, using at least one camera, a video feed of at least a portion of a real estate property,
   determine, using at least the video feed, one or more identifiers of an individual entering the real estate property,
   determine, based at least on the one or more identifiers and by using one or more machine learning models, a match to an entry in a database of suspicious individuals (DSI),
   determine a strength of the match to the entry in the DSI,
   compare the strength of the match to a probability threshold associated with the entry in the DSI, and
   when the strength of the match is greater than the probability threshold, transmit an alert to one or more mobile computing devices associated with one or more designated entities.

Clause 12. The system of any clause herein, wherein the one or more identifiers include at least one or more detected biometric identifiers of the individual, and wherein, to determine, based at least on the one or more identifiers, the strength of the match to the entry in the DSI, the one or more processing devices are further configured to execute the instructions to compare the one or more detected biometric identifiers to one or more stored biometric identifiers associated with the entry in the DSI.

Clause 13. The system of any clause herein, wherein the one or more identifiers include at least a detected electronic identifier of an electronic device located proximate to the individual, and wherein, to determine, based at least on the one or more identifiers, the strength of the match to the entry in the DSI, the one or more processing devices are further configured to execute the instructions to compare the detected electronic identifier to a stored electronic identifier associated with the entry in the DSI.

Clause 14. The system of any clause herein, wherein the one or more processing devices are further configured to execute the instructions to:
transmit a warning to the electronic device, wherein the warning indicates that the individual should leave the real estate property.

Clause 15. The system of any clause herein, wherein the one or more processing devices are further configured to execute the instructions to:
determine, based on the entry in the DSI, that the individual is wanted by one or more law enforcement agencies, and
responsive to determining that the individual is wanted by the one or more law enforcement agencies, transmit a notification to at least one of the one or more law enforcement agencies.

Clause 16. The system of any clause herein, wherein the one or more processing devices are further configured to execute the instructions to:
determine, based at least on one or more attributes of the real estate property, the probability threshold associated with the entry in the DSI.

Clause 17. The system of any clause herein, wherein the one or more attributes of the real estate property comprise at least one selected from the group consisting of a type of goods stored at the real estate property, a service provided at the real estate property, and an affiliation of the real estate property.

Clause 18. The system of any clause herein 1, wherein the one or more processing devices are further configured to execute the instructions to:
determine a risk score for the entry in the DSI, and
determine, based at least on the risk score, the probability threshold associated with the entry in the DSI,
wherein the probability threshold is inversely related to the risk score.

Clause 19. The system of any clause herein, wherein the individual is a first individual, wherein the one or more processing devices are further configured to execute the instructions to:
determine, using at least the video feed, one or more identifiers of a second individual entering the real estate property,
determine, based at least on the one or more identifiers of the second individual, that the second individual is not included in the DSI or in a database of excluded individuals,
determine one or more attributes of the second individual,
determine, based at least on the one or more attributes, a threat score for the second individual,
compare the threat score to a suspicion threshold, and
when the threat score is greater than the suspicion threshold, add the second individual to a database of concerning individuals.

Clause 20. A tangible, non-transitory computer-readable medium storing instructions that, when executed, cause one or more processing devices to:
capture, using at least one camera, a video feed of at least a portion of a real estate property;
determine, using at least the video feed, one or more identifiers of an individual entering the real estate property;
determine, based at least on the one or more identifiers and by using one or more machine learning models, a match to an entry in a database of suspicious individuals (DSI);
determine a strength of the match to the entry in the DSI;
compare the strength of the match to a probability threshold associated with the entry in the DSI; and
when the strength of the match is greater than the probability threshold, transmit an alert to one or more mobile computing devices associated with one or more designated entities.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle.

What is claimed is:

1. A computer-implemented method comprising:
capturing, using at least one camera, a video feed of at least a portion of a real estate property;
determining, using at least the video feed, one or more identifiers of an individual entering the real estate property;
detecting, based at least on the one or more identifiers and by using one or more machine learning models, a match to an entry in a database of suspicious individuals (DSI);
determining a strength of the match to the entry in the DSI;
determining that the strength of the match is greater than a probability threshold associated with the entry in the DSI; and
responsive to determining that the strength of the match is above the probability threshold, transmitting an alert to one or more mobile computing devices associated with one or more designated entities.

2. The computer-implemented method of claim 1, wherein the one or more identifiers include at least one or more detected biometric identifiers of the individual, and wherein determining, based at least on the one or more identifiers, the strength of the match to the entry in the DSI further comprises comparing the one or more detected biometric identifiers to one or more stored biometric identifiers associated with the entry in the DSI.

3. The computer-implemented method of claim 1, wherein the one or more identifiers include at least a detected electronic identifier of an electronic device located proximate to the individual, and wherein determining, based at least on the one or more identifiers, the strength of the match to the entry in the DSI further comprises comparing the detected electronic identifier to a stored electronic identifier associated with the entry in the DSI.

4. The computer-implemented method of claim 3, further comprising:
transmitting a warning to the electronic device, wherein the warning indicates that the individual should leave the real estate property.

5. The computer-implemented method of claim 1, further comprising:
determining, based on the entry in the DSI, that the individual is wanted by one or more law enforcement agencies; and
responsive to determining that the individual is wanted by the one or more law enforcement agencies, transmitting a notification to at least one of the one or more law enforcement agencies.

6. The computer-implemented method of claim 1, further comprising:
determining, based at least on one or more attributes of the real estate property, the probability threshold associated with the entry in the DSI.

7. The computer-implemented method of claim 6, wherein the one or more attributes of the real estate property comprise at least one attribute selected from the group consisting of a type of goods stored at the real estate property, a service provided at the real estate property, and an affiliation of the real estate property.

8. The computer-implemented method of claim 1, further comprising:
determining a risk score for the entry in the DSI; and
determining, based at least on the risk score, the probability threshold associated with the entry in the DSI,
wherein the probability threshold is inversely related to the risk score.

9. The computer-implemented method of claim 1, wherein the entry is a first entry, wherein the probability threshold is a first probability threshold, wherein the DSI further includes at least a second entry associated with a second probability threshold, and wherein the method further comprises:
determining a first risk score for the first entry;
determining, based at least on the first risk score, the first probability threshold;
determining a second risk score for the second entry, wherein the second risk score is greater than the first risk score; and
determining, based at least on the second risk score, the second probability threshold, wherein the second probability threshold is less than the first probability threshold.

10. The computer-implemented method of claim 1, wherein the individual is a first individual, wherein the method further comprises:
determining, using at least the video feed, one or more identifiers of a second individual entering the real estate property;
determining, based at least on the one or more identifiers of the second individual, that the second individual is not included in the DSI or in a database of excluded individuals;
determining one or more attributes of the second individual;
determining, based at least on the one or more attributes, a threat score for the second individual;
determining that the threat score is greater than a suspicion threshold; and
responsive to determining that the threat score is greater than the suspicion threshold, adding the second individual to a database of concerning individuals.

11. A system comprising:
one or more memory devices storing instructions; and
one or more processing devices communicatively coupled to the one or more memory devices, wherein the one or more processing devices are configured to execute the instructions to:
capture, using at least one camera, a video feed of at least a portion of a real estate property,
determine, using at least the video feed, one or more identifiers of an individual entering the real estate property,
determine, based at least on the one or more identifiers and by using one or more machine learning models, a match to an entry in a database of suspicious individuals (DSI),
determine a strength of the match to the entry in the DSI,
compare the strength of the match to a probability threshold associated with the entry in the DSI, and
when the strength of the match is greater than the probability threshold, transmit an alert to one or more mobile computing devices associated with one or more designated entities.

12. The system of claim 11, wherein the one or more identifiers include at least one or more detected biometric identifiers of the individual, and wherein, to determine, based at least on the one or more identifiers, the strength of the match to the entry in the DSI, the one or more processing devices are further configured to execute the instructions to compare the one or more detected biometric identifiers to one or more stored biometric identifiers associated with the entry in the DSI.

13. The system of claim 11, wherein the one or more identifiers include at least a detected electronic identifier of an electronic device located proximate to the individual, and wherein, to determine, based at least on the one or more identifiers, the strength of the match to the entry in the DSI, the one or more processing devices are further configured to execute the instructions to compare the detected electronic identifier to a stored electronic identifier associated with the entry in the DSI.

14. The system of claim 13, wherein the one or more processing devices are further configured to execute the instructions to:
transmit a warning to the electronic device, wherein the warning indicates that the individual should leave the real estate property.

15. The system of claim 11, wherein the one or more processing devices are further configured to execute the instructions to:
determine, based on the entry in the DSI, that the individual is wanted by one or more law enforcement agencies, and
responsive to determining that the individual is wanted by the one or more law enforcement agencies, transmit a notification to at least one of the one or more law enforcement agencies.

16. The system of claim 11, wherein the one or more processing devices are further configured to execute the instructions to:
determine, based at least on one or more attributes of the real estate property, the probability threshold associated with the entry in the DSI.

17. The system of claim 16, wherein the one or more attributes of the real estate property comprise at least one attribute selected from the group consisting of a type of goods stored at the real estate property, a service provided at the real estate property, and an affiliation of the real estate property.

18. The system of claim 11, wherein the one or more processing devices are further configured to execute the instructions to:
determine a risk score for the entry in the DSI, and
determine, based at least on the risk score, the probability threshold associated with the entry in the DSI,
wherein the probability threshold is inversely related to the risk score.

19. The system of claim 11, wherein the individual is a first individual, wherein the one or more processing devices are further configured to execute the instructions to:
determine, using at least the video feed, one or more identifiers of a second individual entering the real estate property,
determine, based at least on the one or more identifiers of the second individual, that the second individual is not included in the DSI or in a database of excluded individuals,
determine one or more attributes of the second individual,
determine, based at least on the one or more attributes, a threat score for the second individual,
compare the threat score to a suspicion threshold, and
when the threat score is greater than the suspicion threshold, add the second individual to a database of concerning individuals.

20. A tangible, non-transitory computer-readable medium storing instructions that, when executed, cause one or more processing devices to:
capture, using at least one camera, a video feed of at least a portion of a real estate property;
determine, using at least the video feed, one or more identifiers of an individual entering the real estate property;
determine, based at least on the one or more identifiers and by using one or more machine learning models, a match to an entry in a database of suspicious individuals (DSI);
determine a strength of the match to the entry in the DSI;
compare the strength of the match to a probability threshold associated with the entry in the DSI; and
when the strength of the match is greater than the probability threshold, transmit an alert to one or more mobile computing devices associated with one or more designated entities.
